(19) United States
(12) Patent Application Publication
(10) Pub. No.: US 2023/0300966 A1
(43) Pub. Date: Sep. 21, 2023

(54) EXTREME ULTRAVIOLET LIGHT GENERATION APPARATUS AND ELECTRONIC DEVICE MANUFACTURING METHOD

(71) Applicant: Gigaphoton Inc., Tochigi (JP)

(72) Inventor: Shogo KITASAKA, Oyama-shi (JP)

(73) Assignee: Gigaphoton Inc., Tochigi (JP)

(21) Appl. No.: 18/164,535

(22) Filed: Feb. 3, 2023

(30) Foreign Application Priority Data
Mar. 15, 2022 (JP) 2022-040629

(51) Int. Cl. H05G 2/00

(52) U.S. Cl. CPC H05G 2/008; H05G 2/006

(57) ABSTRACT

An extreme ultraviolet light generation apparatus includes a target supply unit, a target passage detection device, a delay circuit, a laser device, a target image capturing device, and a processor. Here, the processor controls the vibrating element so that an interval between the adjacent droplet targets becomes irregular, specifies the droplet targets with which standard deviation of a distance from the second detection position to each droplet target is equal to or less than a first threshold, and sets the delay time based on a distance from each of the specified droplet targets to the second detection position so that the specified droplet targets are to be located at the second detection position.

The present application claims the benefit of Japanese Patent Application No. 2022-040629, filed on Mar. 15, 2022, the entire contents of which are hereby incorporated by reference.

### BACKGROUND

### 1. Technical Field

The present disclosure relates to an extreme ultraviolet light generation apparatus and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

As the EUV light generation apparatus, a laser produced plasma (LPP) type apparatus using plasma generated by irradiating a target substance with laser light has been developed.

### LIST OF DOCUMENTS

### Patent Documents

Patent Document 1: US Patent Application Publication No. 2021/0048752

Patent Document 2: U.S. Pat. No. 9,277,635

Patent Document 3: U.S. Pat. No. 8,324,600

### SUMMARY

An extreme ultraviolet light generation apparatus according to an aspect of the present disclosure may include a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance; a target passage detection device configured to detect passage of the droplet target, at a first detection position, supplied from the target supply unit into a chamber and output a passage timing signal at each time of the detection; a delay circuit configured to receive the passage timing signal and output a light emission trigger signal and an imaging trigger signal at a timing delayed by a given delay time from the reception of the passage timing signal; a laser device configured to generate extreme ultraviolet light by irradiating, with laser light, the droplet target at a second detection position on a downstream side from the first detection position in a travel direction of the droplet target, at each time the light emission trigger signal is input; a target image capturing device configured to image the droplet target located in a region including the second detection position and generate image data of the region and the droplet target located in the region, at each time the imaging trigger signal is input; and a processor. Here, the processor may be configured to control the vibrating element so that an interval between the adjacent droplet targets becomes irregular, specify the droplet targets with which standard deviation of a distance from the second detection position to each droplet target is equal to or less than a first threshold, and set the delay time based on a distance from each of the specified droplet targets to the second detection position so that the specified droplet targets are to be located at the second detection position.

An electronic device manufacturing method according to an aspect of the present disclosure may include outputting extreme ultraviolet light generated using an extreme ultraviolet light generation apparatus to an exposure apparatus, and exposing a photosensitive substrate to the extreme ultraviolet light in the exposure apparatus to manufacture an electronic device. Here, the extreme ultraviolet light generation apparatus may include a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance; a target passage detection device configured to detect passage of the droplet target, at a first detection position, supplied from the target supply unit into a chamber and output a passage timing signal at each time of the detection; a delay circuit configured to receive the passage timing signal and output a light emission trigger signal and an imaging trigger signal at a timing delayed by a given delay time from the reception of the passage timing signal; a laser device configured to generate the extreme ultraviolet light by irradiating, with laser light, the droplet target at a second detection position on a downstream side from the first detection position in a travel direction of the droplet target, at each time the light emission trigger signal is input; a target image capturing device configured to image the droplet target located in a region including the second detection position and generate image data of the region and the droplet target located in the region, at each time the imaging trigger signal is input; and a processor. The processor may be configured to control the vibrating element so that an interval between the adjacent droplet targets becomes irregular, specify the droplet target with which standard deviation of a distance from the second detection position to each droplet target is equal to or less than a first threshold, and set the delay time based on a distance from each of the specified droplet targets to the second detection position so that the specified droplet targets are to be located at the second detection position.

An electronic device manufacturing method according to another aspect of the present disclosure may include inspecting a defect of a mask by irradiating the mask with extreme ultraviolet light generated using an extreme ultraviolet light generation apparatus, selecting a mask using a result of the inspection, and exposing and transferring a pattern formed on the selected mask onto a photosensitive substrate. Here, the extreme ultraviolet light generation apparatus may include a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance; a target passage detection device configured to detect passage of the droplet target, at a first detection position, supplied from the target supply unit into a chamber and output a passage timing signal at each time of the detection; a delay circuit configured to receive the passage timing signal and output a light emission trigger signal and an imaging trigger signal at a timing delayed by a given delay time from the reception of the passage timing signal; a laser device configured to generate the extreme ultraviolet light by irradiating, with laser light, the droplet target at a second detection position on a downstream side from the first detection position in a travel direction of the droplet target, at each time the light emission trigger signal is input; a target image capturing device configured to image the droplet target located in a region including the second detection position and generate image data of the region and the droplet target located in the region, at each time the imaging trigger signal is input; and a processor. The processor may be configured to control the vibrating element so that an interval between the adjacent droplet targets becomes irregular, specify the droplet target with which standard deviation of a distance from the second detection position to each droplet target is equal to or less than a first threshold, and set the delay time based on a distance from each of the specified droplet targets to the second detection position so that the specified droplet targets are to be located at the second detection position.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire electronic device manufacturing apparatus different from the electronic device manufacturing apparatus shown in FIG. 1.

FIG. 3 is a schematic view showing a schematic configuration example of an entire extreme ultraviolet light generation apparatus of a comparative example.

FIG. 4 is a diagram showing a target passage detection device and a target image capturing device of the extreme ultraviolet generation apparatus of the comparative example.

FIG. 5 is a diagram showing an example of a control flowchart of the processor according to the comparative example.

FIG. 6 is a timing chart of the control flowchart shown in FIG. 5.

FIG. 7 is a diagram showing a part of a control flowchart of a processor according to a first embodiment.

FIG. 8 is a diagram showing another part of the control flowchart according to the first embodiment.

FIG. 9 is a diagram showing another part of the control flowchart according to the first embodiment.

FIG. 10 is a diagram showing a remaining part of the control flowchart according to the first embodiment.

FIG. 11 is a part of the control flowchart in a delay time setting process of the first embodiment.

FIG. 12 is another part of a control flowchart in the delay time setting process according to the first embodiment.

FIG. 13 is a remaining part of the control flowchart in the delay time setting process of the first embodiment.

FIG. 14 is a control flowchart of a fine adjustment process of the delay time.

FIG. 15 is a diagram showing a part of a control flowchart of a processor according to a second embodiment.

FIG. 16 is a part of the control flowchart in the delay time setting process of the second embodiment.

FIG. 17 is another part of the control flowchart in the delay time setting process of the second embodiment.

FIG. 18 is a remaining part of the control flowchart in the delay time setting process of the second embodiment.

FIG. 19 is a diagram showing a part of a control flowchart of a processor according to a third embodiment.

FIG. 20 is a part of the control flowchart in the delay time setting process of the third embodiment.

FIG. 21 is another part of the control flowchart in the delay time setting process of the third embodiment.

FIG. 22 is a diagram for explaining allocation in step SP143.

FIG. 23 is a remaining part of the control flowchart in the delay time setting process of the third embodiment.

### DESCRIPTION OF EMBODIMENTS

### 1. Overview

2. Description of electronic device manufacturing apparatus
3. Description of extreme ultraviolet light generation apparatus of comparative example

3.1 Configuration

3.2 Operation

3.3 Problem

4. Description of extreme ultraviolet light generation apparatus of first embodiment

4.1 Configuration

4.2 Operation

4.3 Effect

5. Description of extreme ultraviolet light generation apparatus of second embodiment

5.1 Configuration

5.2 Operation

5.3 Effect

6. Description of extreme ultraviolet light generation apparatus of third embodiment

6.1 Configuration

6.2 Operation

6.3 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numerals, and duplicate description thereof is omitted.

### 1. Overview

Embodiments of the present disclosure relate to an extreme ultraviolet light generation apparatus generating light having a wavelength of extreme ultraviolet (EUV) and an electronic device manufacturing apparatus. In the following, extreme ultraviolet light is referred to as EUV light in some cases.

### 2. Description of Electronic Device Manufacturing Apparatus

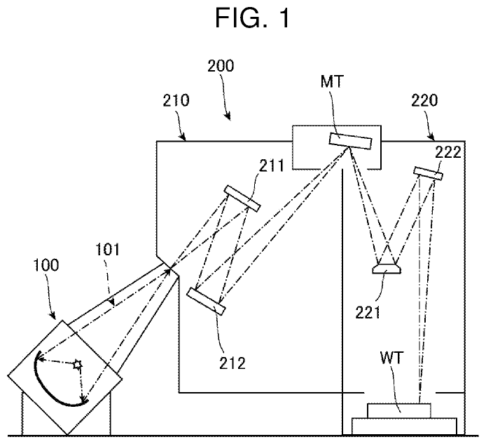

FIG. 1 is a schematic view showing a schematic configuration example of an entire electronic device manufacturing apparatus. The electronic device manufacturing apparatus shown in FIG. 1 includes an EUV light generation apparatus 100 and an exposure apparatus 200. The exposure apparatus 200 includes a mask irradiation unit 210 including a plurality of mirrors 211, 212 that constitute a reflection optical system, and a workpiece irradiation unit 220 including a plurality of mirrors 221, 222 that constitute a reflection optical system different from the reflection optical system of the mask irradiation unit 210. The mask irradiation unit 210 illuminates, via the mirrors 211, 212, a mask pattern of a mask table MT with EUV light 101 incident from the EUV light generation apparatus 100. The workpiece irradiation unit 220 images the EUV light 101 reflected by the mask table MT onto a workpiece (not shown) arranged on a workpiece table WT via the mirrors 221, 222. The workpiece is a photosensitive substrate such as a semiconductor wafer on which photoresist is applied. The exposure apparatus 200 synchronously translates the mask table MT and the workpiece table WT to expose the workpiece to the EUV light 101 reflecting the mask pattern. Through the exposure process as described above, a device pattern is transferred onto the semiconductor wafer, thereby a semiconductor device can be manufactured.

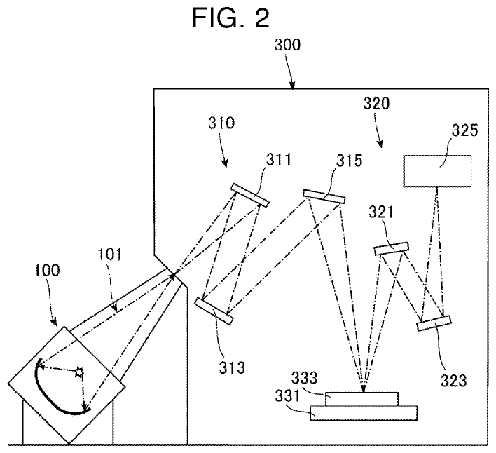

FIG. 2 is a schematic diagram showing an overall schematic configuration example of an inspection apparatus 300 connected to the EUV light generation apparatus 100. The inspection apparatus 300 includes an illumination optical system 310 including a plurality of mirrors 311, 313, 315 that constitute a reflection optical system, and a detection optical system 320 including a detector 325 and a plurality of mirrors 321, 322 that constitute a reflection optical system different from the reflection optical system of the illumination optical system 310. The illumination optical system 310 reflects, with the mirrors 311, 313, 315, the EUV light 101 incident from the EUV light generation apparatus 100 to illuminate a mask 333 placed on a mask stage 331. The mask 333 includes a mask blanks before a pattern is formed. The detection optical system 320 reflects, with the mirrors 321, 323, the EUV light 101 reflecting the pattern from the mask 333 and forms an image on a light receiving surface of the detector 325. The detector 325 having received the EUV light 101 obtains an image of the mask 333. The detector 325 is, for example, a time delay integration (TDI) camera. A defect of the mask 333 is inspected based on the image of the mask 333 obtained by the above-described process, and a mask suitable for manufacturing an electronic device is selected using the inspection result. Then, the electronic device can be manufactured by exposing and transferring the pattern formed on the selected mask onto the photosensitive substrate using the exposure apparatus 200.

### 3. Description of Extreme Ultraviolet Light Generation Apparatus of Comparative Example

### 3.1 Configuration

The EUV light generation apparatus 100 of a comparative example will be described. The comparative example of the present disclosure is an example recognized by the applicant as known only by the applicant, and is not a publicly known example admitted by the applicant. Further, the following description will be given with reference to the EUV light generation apparatus 100 that outputs the EUV light 101 to the exposure apparatus 200 as an external apparatus as shown in FIG. 1. Here, the EUV light generation apparatus 100 that outputs the EUV light 101 to the inspection apparatus 300 as an external apparatus as shown in FIG. 2 can obtain the same operation and effect.

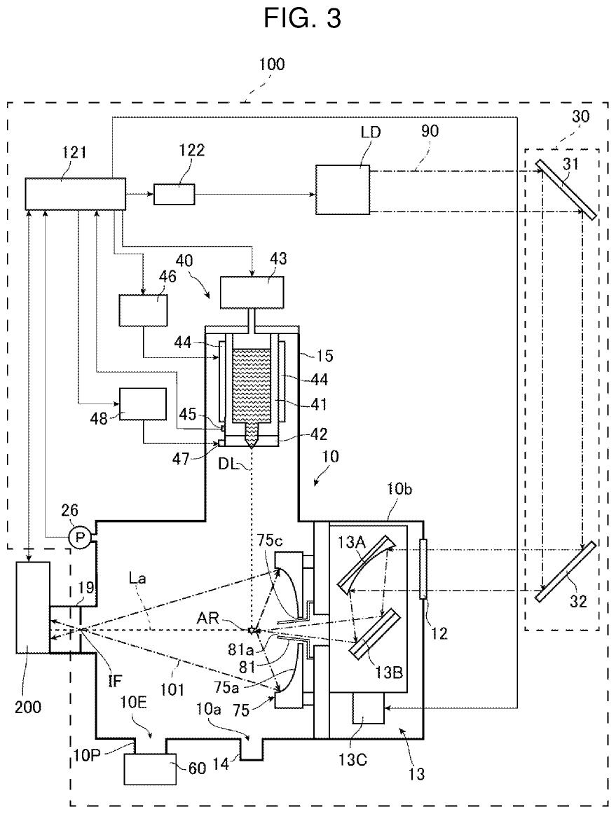

FIG. 3 is a schematic diagram showing a schematic configuration example of the entire EUV light generation apparatus 100 of the present example. As shown in FIG. 3, the EUV light generation apparatus 100 includes a chamber 10, a laser device LD, a laser light delivery optical system 30, a processor 121, and a delay circuit 122 as a main configuration.

The chamber 10 is a sealable container. The chamber 10 includes an inner wall 10b surrounding the internal space having a low pressure atmosphere. The chamber 10 also includes a sub-chamber 15. A target supply unit 40 is attached to the sub-chamber 15 to penetrate a wall of the sub-chamber 15. The target supply unit 40 includes a tank 41, a nozzle 42, and a pressure regulator 43 to supply a droplet target DL to the internal space of the chamber 10. The droplet target DL is sometimes abbreviated as a droplet or a target.

The tank 41 stores therein a target substance which becomes the droplet target DL. The target substance contains tin. The interior of the tank 41 is in communication with the pressure regulator 43 which regulates the pressure in the tank 41 constant. A heater 44 and a temperature sensor 45 are attached to the tank 41. The heater 44 heats the tank 41 with current applied from a heater power source 46. Through the heating, the target substance in the tank 41 melts. The temperature sensor 45 measures, via the tank 41, the temperature of the target substance in the tank 41. The pressure regulator 43, the temperature sensor 45, and the heater power source 46 are electrically connected to the processor 121.

The nozzle 42 is attached to the tank 41 and outputs the target substance. A piezoelectric element 47 serving as a vibrating element is attached to the nozzle 42. The piezoelectric element 47 is electrically connected to a piezoelectric power source 48 and is driven by voltage applied from the piezoelectric power source 48. The piezoelectric power source 48 is electrically connected to the processor 121. The piezoelectric element 47 applies vibration to the target substance to be output from the nozzle 42 to generate droplet targets DL of the target substance.

The chamber 10 includes a target collection unit 14. The target collection unit 14 is a box body attached to an inner wall 10b of the chamber 10 and communicates with the internal space of the chamber 10 via an opening 10a formed at the inner wall 10b of the chamber 10. The opening 10a is arranged directly below the nozzle 42. The target collection unit 14 is a drain tank to collect any unnecessary droplet target DL having passed through the opening 10a and reaching the target collection unit 14.

At least one through hole is formed in the inner wall 10b of the chamber 10. The through hole is blocked by a window 12 through which pulse laser light 90 output from the laser device LD passes.

Further, a laser light concentrating optical system 13 is arranged at the internal space of the chamber 10. The laser light concentrating optical system 13 includes a laser light concentrating mirror 13A and a high reflection mirror 13B. The laser light concentrating mirror 13A reflects and concentrates the laser light 90 having passed through the window 12. The high reflection mirror 13B reflects the laser light 90 concentrated by the laser light concentrating mirror 13A. Positions of the laser light concentrating mirror 13A and the high reflection mirror 13B are adjusted by a laser light manipulator 13C so that a concentration position of the laser light 90 at the internal space of the chamber 10 coincides with a position specified by the processor 121. The concentration position is adjusted to be a position directly below the nozzle 42, and when the target substance is irradiated with the laser light 90 at the concentration position, plasma is generated by the irradiation, and the EUV light 101 is radiated from the plasma. The region in which plasma is generated is sometimes referred to as a plasma generation region AR.

For example, an EUV light concentrating mirror 75 having a spheroidal reflection surface 75a is arranged at the internal space of the chamber 10. The reflection surface 75a reflects the EUV light 101 radiated from the plasma in the plasma generation region AR. The reflection surface 75a has a first focal point and a second focal point. The reflection surface 75a may be arranged such that, for example, the first focal point is located in the plasma generation region AR and the second focal point is located at an intermediate focal point IF. In FIG. 3, a straight line passing through the first focal point and the second focal point is shown as a focal line La. The focal line La is extended along the center axis direction of the reflection surface 75a.

Further, the EUV light generation apparatus 100 includes a connection portion 19 providing communication between the internal space of the chamber 10 and the internal space of the exposure apparatus 200. A wall in which an aperture is formed is arranged inside the connection portion 19. The wall is preferably arranged such that the aperture is located at the second focal point. The connection portion 19 is an outlet port of the EUV light 101 in the EUV light generation apparatus 100, and the EUV light 101 is output from the connection portion 19 and enters the exposure apparatus 200.

Further, the EUV light generation apparatus 100 includes a pressure sensor 26. The pressure sensor 27 is attached to the chamber 10 and is electrically connected to the processor 121. The pressure sensor 26 measures the pressure at the internal space of the chamber 10 and outputs a signal indicating the pressure to the processor 121.

The processor 121 of the present disclosure is a processing device including a storage device in which a control program is stored and a central processing unit (CPU) that executes the control program. The processor 121 is specifically configured or programmed to perform various processes included in the present disclosure and controls the entire EUV light generation apparatus 100. The processor 121 receives a signal related to the pressure at the internal space of the chamber 10, which is measured by the pressure sensor 26, a burst signal instructing the burst operation from the exposure apparatus 200, and the like. The processor 121 processes the various signals, and may control, for example, the timing at which the droplet target DL is output, the output direction of the droplet target DL, and the like. Further, the processor 121 may control the output timing of the laser device LD, the travel direction and the concentration position of the laser light 90, and the like. Such various kinds of control described above are merely exemplary, and other control may be added as necessary, as described later.

The processor 121 of the present example is electrically connected to the laser device LD via the delay circuit 122. The delay circuit 122 receives a passage timing signal from a target passage detection device described later via the processor 121. The delay circuit 122 outputs a light emission trigger signal to the laser device LD at a timing delayed by a given delay time from the input of the passage timing signal.

When the light emission trigger signal is input, the laser device LD outputs the laser light 90. The laser device LD includes a master oscillator being a light source to perform burst operation. The master oscillator outputs the pulse laser light 90 in a burst-on duration. The master oscillator is, for example, a laser device configured to output the laser light 90 by exciting, through electric discharge, a gas as mixture of a carbon dioxide gas with helium, nitrogen, or the like. Alternatively, the master oscillator may be a quantum cascade laser device. The master oscillator may output the pulse laser light 90 by a Q switch system. Further, the master oscillator may include an optical switch, a polarizer, and the like. In the burst operation, the pulse laser light 90 is continuously output at a predetermined repetition frequency in the burst-on duration and the output of the laser light 90 is stopped in a burst-off duration.

A travel direction of the laser light 90 output from the laser device LD is adjusted by the laser light delivery optical system 30. The laser light delivery optical system 30 includes a plurality of mirrors 31, 32 for adjusting the travel direction of the laser light 90. The position of at least one of the mirrors 31, 32 is adjusted by an actuator (not shown). Owing to that the position of at least one of the mirrors 31, 32 is adjusted, the laser light 90 can appropriately propagate to the internal space of the chamber 10 through the window 12.

A central gas supply unit 81 for supplying etching gas to the internal space of the chamber 10 is arranged at the chamber 10. As described above, since the target substance contains tin, the etching gas is, for example, a hydrogen-containing gas having hydrogen gas concentration of 100% in effect. Alternatively, the etching gas may be, for example, a balance gas having hydrogen gas concentration of approximately 3%. The balance gas contains a nitrogen (N₂) gas and an argon (Ar) gas. Tin fine particles and tin charged particles are generated when the target substance constituting the droplet target DL is turned into plasma in the plasma generation region AR by being irradiated with main pulse laser light MPL. Tin constituting these fine particles and charged particles reacts with hydrogen contained in the etching gas supplied to the internal space of the chamber 10. Through the reaction with hydrogen, tin becomes stannane (SnH₄) gas at room temperature.

The central gas supply unit 81 has a side surface shape of a circular truncated cone, and is inserted through a through hole 75c formed in the center of the EUV light concentrating mirror 75. The central gas supply unit 81 is called a cone in some cases. Further, the central gas supply unit 81 has a central gas supply port 81a being a nozzle. The central gas supply port 81a is provided on the focal line La at the reflection surface 75a. The central gas supply port 81a supplies the etching gas from the center side of the reflection surface 75a toward the plasma generation region AR. Here, it is preferable that the etching gas is supplied from the central gas supply port 81a along the focal line La in the direction away from the reflection surface 75a from the center side of the reflection surface 75a. The central gas supply port 81a is connected to a gas supply device (not shown) being a tank through a pipe (not shown) of the central gas supply unit 81 and the etching gas is supplied therefrom. The gas supply device is driven and controlled by the processor 121. A supply gas flow rate adjusting unit being a valve (not shown) may be arranged in the pipe (not shown).

The central gas supply port 81a is a gas supply port for supplying the etching gas to the internal space of the chamber 10 as well as an output port through which the laser light 90 is output to the internal space of the chamber 10. The laser light 90 travels toward the internal space of the chamber 10 through the window 12 and the central gas supply port 81a.

An exhaust port 10E is arranged at the inner wall 10b of the chamber 10. Since the exposure apparatus 200 is arranged on the focal line La, the exhaust port 10E is arranged at the inner wall 10b on the side lateral to the focal line La. The direction along the center axis of the exhaust port 10E is, for example, perpendicular to the focal line La. The exhaust port 10E is arranged on the side opposite to the reflection surface 75a with respect to the plasma generation region AR when viewed from the direction perpendicular to the focal line La. The exhaust port 10E exhausts gas at the internal space of the chamber 10. The exhaust port 10E is connected to an exhaust pipe 10P, and the exhaust pipe 10P is connected to an exhaust pump 60.

As described above, when the target substance is turned into plasma in the plasma generation region AR, the residual gas as exhaust gas is generated at the internal space of the chamber 10. The residual gas contains the fine particles and charged particles of tin generated through the plasma generation from the target substance, stannane generated through the reaction of the fine particles and charged particles of tin with the etching gas, and an unreacted etching gas. Some of the charged particles are neutralized at the internal space of the chamber 10, and the residual gas contains the neutralized charged particles as well. The residual gas is suctioned to the exhaust pump 60 through the exhaust port 10E and the exhaust pipe 10P.

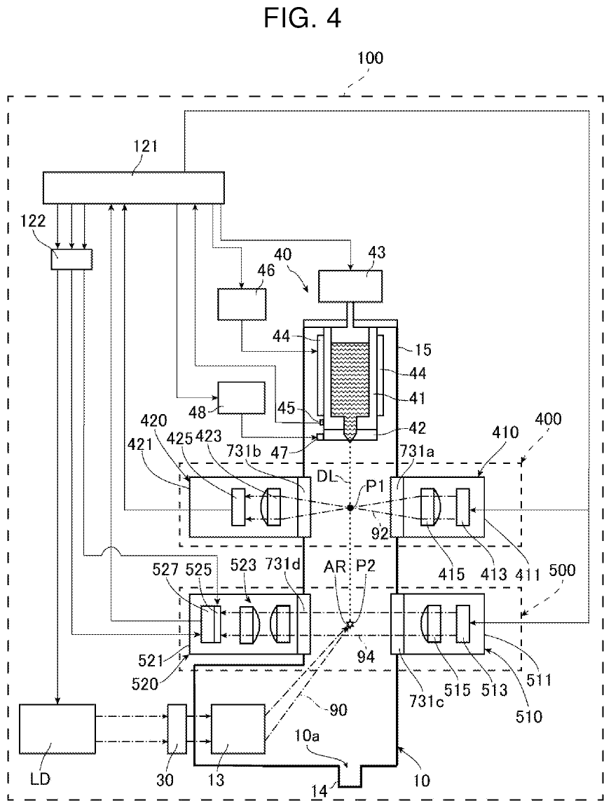

FIG. 4 is a diagram showing a target passage detection device and a target image capturing device arranged in the chamber 10 of the EUV light generation apparatus 100 of the present example. In FIG. 4, some of the members such as the EUV light concentrating mirror 75 shown in FIG. 3 are not shown. Hereinafter, the target passage detection device may be simply referred to as a detection device 400, and the target image capturing device may be simply referred to as an imaging device 500.

The detection device 400 is arranged upstream of the imaging device 500 in the travel direction of the droplet target DL. The detection device 400 detects the passage of the droplet target DL, and the imaging device 500 images the droplet target DL.

The detection device 400 includes an illumination unit 410 and a detection unit 420. The illumination unit 410 is arranged on the side opposite to the detection unit 420 with respect to the trajectory of the droplet target DL. The direction in which the illumination unit 410 and the detection unit 420 are arranged is perpendicular to the trajectory, but may not be perpendicular to the trajectory. The illumination unit 410 and the detection unit 420 are attached to the inner wall 10b at the outside of the chamber 10, the illumination unit 410 is arranged coaxially with the window 731a provided in the inner wall 10b, and the detection unit 420 is arranged coaxially with the window 731 provided in the inner wall 10b.

The illumination unit 410 includes a container 411, and a light source 413 and an illumination optical system 415 that are accommodated in the container 411. The light source 413 is electrically connected to the processor 121, and the emission timing of the light 92 output from the light source 413 is controlled. The light source 413 may be, for example, a light source that outputs monochromatic laser light or a flash lamp that outputs light including a plurality of wavelengths. The illumination optical system 415 includes a light concentrating lens and concentrates the light 92 on the trajectory of the droplet target DL via the window 731a.

The detection unit 420 includes a container 421, and a light receiving optical system 423 and an optical sensor 425 that are accommodated in the container 421. The light receiving optical system 423 includes a lens that transfers an image of the droplet target DL illuminated with the light 92 onto the optical sensor 425. The optical sensor 425 is, for example, a photodiode or the like. When the droplet target DL blocks the light 92, the amount of light 92 received by the optical sensor 425 varies. The optical sensor 425 generates a passage timing signal indicating the passage of the droplet target DL based on the variation and outputs the passage timing signal to the processor 121. Hereinafter, the detection position of the detection device 400 with respect to the droplet target DL may be referred to as a first detection position P1. The first detection position P1 is located between the illumination unit 410 and the detection unit 420 of the detection device 400, and is a concentration position of the light 92 from the illumination unit 410 on the trajectory of the droplet target DL.

The imaging device 500 includes an illumination unit 510 and an imaging unit 520. The illumination unit 510 is arranged on the side opposite to the imaging unit 520 with respect to the trajectory of the droplet target DL. The direction in which the illumination unit 510 and the imaging unit 520 are arranged is perpendicular to the trajectory, but may not be perpendicular to the trajectory. The illumination unit 510 and the imaging unit 520 are attached to the inner wall 10b at the outside of the chamber 10, the illumination unit 510 is arranged coaxially with the window 731c provided in the inner wall 10b, and the imaging unit 520 is arranged coaxially with the window 731d provided in the inner wall 10b.

The illumination unit 510 includes a container 521, and a light source 513 and an illumination optical system 515 that are accommodated in the container 521. The light source 513 is electrically connected to the processor 121, and the emission timing of the light 94 output from the light source 513 toward the droplet target DL in the plasma generation region AR is controlled. The light source 513 is, for example, a flash lamp that emits light including a plurality of wavelengths. The illumination optical system 515 includes a collimator lens.

The imaging unit 520 includes a container 521, and an imaging optical system 523, a shutter 525, and an imaging body unit 527 that are accommodated in the container 521. The imaging optical system 523 includes a first lens and a second lens. The shutter 525 is electrically connected to the delay circuit 122. The imaging body unit 527 is, for example, a charge-coupled device (CCD) or the like, and is electrically connected to the processor 121 and the delay circuit 122. When the passage timing signal is input from the detection device 400, the processor 121 outputs an imaging trigger signal to each of the shutter 525 and the imaging body unit 527 via the delay circuit 122 with a delay of a given delay time from the input of the passage timing signal. Hereinafter, the imaging trigger signal for the shutter 525 may be referred to as a shutter trigger signal, and the imaging trigger signal for the imaging body unit 527 may be referred to as an imaging trigger signal. When the shutter trigger signal is input from the delay circuit 122, the shutter 525 opens for an extremely short time and then closes. The imaging body unit 527 receives the imaging trigger signal from the delay circuit 122 and receives the light 94 while the shutter 525 is open. Then, the imaging body unit 527 generates image data by imaging the droplet target DL and outputs the image data to the processor 121 as an electric signal. Hereinafter, the detection position of the imaging device 500 with respect to the droplet target DL may be referred to as a second detection position P2. The second detection position P2 is located on the downstream side of the first detection position P1 in the travel direction of the droplet target DL, and in the plasma generation region AR and in the illumination region of the light 92 from the illumination unit 510 on the trajectory of the droplet target DL.

In the following, a direction along the trajectory of the droplet target DL may be referred to as a Y direction, a direction in which the illumination unit 410 and the detection unit 420 are arranged and which is perpendicular to the Y direction may be referred to as an X direction, and a direction perpendicular to the Y direction and the X direction may be referred to as a Z direction. The X direction is also a direction in which the illumination unit 510 and the imaging unit 520 are arranged.

### 3.2 Operation

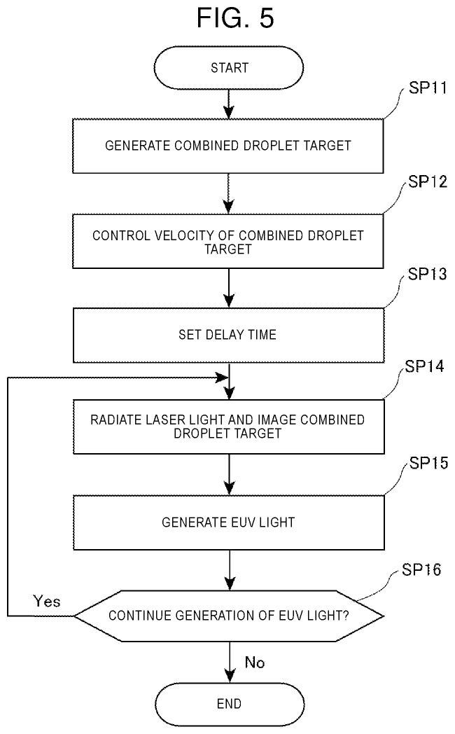

Next, operation of the processor 121 of the comparative example will be described. FIG. 5 is a diagram showing an example of a control flowchart of the processor 121 according to the comparative example. This control flow includes steps SP11 to SP16. In the start state shown in FIG. 3, the processor 121 receives a drive instruction signal for the target supply unit 40 from the exposure processor of the exposure apparatus 200. In addition, in the start state, the processor 121 causes the light 92 to be output from the illumination unit 410 and the light 94 to be output from the illumination unit 510.

(Step SP11) In the present step, in order to heat and maintain the target substance in the tank 41 to and at a predetermined temperature equal to or higher than the melting point, the processor 121 causes the heater power source 46 to supply current to the heater 44 to increase temperature of the heater 44. In this case, the processor 121 controls the temperature of the target substance to the predetermined temperature by adjusting a value of the current supplied from the heater power source 46 to the heater 44 based on an output from the temperature sensor 45. When the target substance is tin, the predetermined temperature is equal to or higher than 231.93° C. being the melting point of tin, for example, 240° C. or higher and 290° C. or lower. Thus, the preparation for outputting the droplet target DL is completed.

When the preparation is completed, the processor 121 causes the pressure regulator 43 to supply the inert gas from a gas supply source (not shown) to the tank 41 and to regulate the pressure in the tank 41 so that the melted target substance is output through the nozzle hole of the nozzle 42 at a predetermined velocity. Under this pressure, the target substance is output into the chamber 10 through the nozzle hole of the nozzle 42. The target substance output through the nozzle hole may be in the form of a jet. At this time, the processor 121 causes the piezoelectric power source 48 to apply voltage having a predetermined waveform to the piezoelectric element 47 to generate the droplet target DL. The piezoelectric power source 48 applies voltage so that the waveform of the voltage value becomes, for example, a sine wave, a rectangular wave, or a sawtooth wave. Thus, the piezoelectric element 47 vibrates at a predetermined frequency. Vibration of the piezoelectric element 47 can propagate through the nozzle 42 to the target substance to be output through the nozzle hole of the nozzle 42. The target substance is divided at a predetermined cycle by the vibration and becomes droplet targets DL of a liquid droplet, and an interval between the adjacent droplet targets DL is substantially constant. Hereinafter, the droplet target DL in which the interval between the adjacent droplet targets DL is substantially constant may be referred to as a combined droplet target DL. Therefore, in the present step, the processor 121 drives the piezoelectric element 47 to generate and output the combined droplet target DL. The diameter of the droplet target DL is approximately 20 μm or less. After outputting the droplet target DL, the processor 121 advances the control flow to step SP12. All of the droplet targets DL in the following steps of the present example are the combined droplet targets DL.

Prior to step SP12, the droplet target DL output from the target supply unit 40 travels to the target collection unit 14. In this course, the droplet target DL passes through the first detection position P1 of the detection device 400 with respect to the droplet target DL, and the second detection position P2 of the imaging device 500 with respect to the droplet target DL, that is, the plasma generation region AR.

When the droplet target DL passes through the first detection position P1, the droplet target DL blocks the light 92 from the light source 413 of the detection device 400. As a result, the amount of light received by the optical sensor 425 of the detection device 400 varies. The optical sensor 425 generates the passage timing signal indicating the passage of the droplet target DL based on the variation and outputs the passage timing signal to the processor 121. Each time the droplet target DL blocks the light 92, the optical sensor 425 outputs the passage timing signal. Thus, the detection device 400 detects the passage, at the first detection position P1, of the droplet target DL supplied from the target supply unit 40 into the chamber 10, and outputs the passage timing signal to the processor 121 each time the detection is performed.

The processor 121 performs mask processing on the plurality of input passage timing signals and recognizes only passage timing signals at predetermined time intervals among the plurality of input passage timing signals. The number of the recognized passage timing signals is plural but less than the number of the passage timing signals input to the processor 121. The droplet target DL corresponding to the recognized passage timing signal is an imaging target of the imaging device 500 and an irradiation target of the laser light 90 of the laser device LD. That is, not all of the droplet targets DL are the imaging targets and the irradiation targets, but the droplet targets DL at approximately a predetermined cycle among all of the droplet targets DL are the imaging targets and the irradiation targets. Then, the processor 121 inputs a trigger signal, which is a signal serving as a starting point of the imaging trigger signal and the light emission trigger signal, to the delay circuit 122 for each of the passage timing signals recognized after the mask processing. The trigger signal can also be understood as the passage timing signal input to the delay circuit 122 via the processor 121. Each time the trigger signal is input, the delay circuit 122 outputs the imaging trigger signal to the shutter 525 and the imaging body unit 527 and outputs the light emission trigger signal to the laser device LD at a timing delayed by a given delay time from the input of the trigger signal. Therefore, it can be understood that the processor 121 outputs the imaging trigger signal and the light emission trigger signal via the delay circuit 122 with a delay of the given delay time from the input of the passage timing signal recognized after the mask processing.

When the imaging trigger signal is input, the shutter 525 is opened, and the imaging body unit 527 images the droplet target DL located in a predetermined imaging region including the second detection position P2 while the shutter 525 is open. Then, the imaging body unit 527 generates image data of the imaging region and the droplet target DL located in the imaging region.

The imaging trigger signal is individually output in accordance with each of the plurality of passage timing signals recognized after the mask processing. Each time the imaging trigger signal is input, the imaging device 500 images the droplet target DL located in the imaging region including the second detection position P2 and generates the image data of the imaging region and the droplet target DL located in the imaging region. The imaging body unit 527 outputs each image data to the processor 121 as an electric signal. Since the imaging body unit 527 is driven by the imaging trigger signal, the imaging device 500 can image the droplet target DL which is detected by the detection device 400 to pass through the first detection position P1 and which becomes a measurement target through the mask processing of the processor 121. That is, the imaging device 500 can perform imaging in synchronization with the timing at which the droplet target DL that has passed through the first detection position P1 is located at the second detection position P2.

(Step SP12) In the present step, the processor 121 calculates the target velocity of the droplet target DL from the frequency of the piezoelectric element 47 and the interval between the adjacent droplet targets DL. The interval between the adjacent droplet targets DL is measured by the processor 121 from the image data of the droplet targets DL imaged by the imaging body unit 527. Then, the processor 121 adjusts the pressure in the tank 41 by the pressure regulator 43 so that the molten target substance is output from the nozzle hole of the nozzle 42 at the target velocity and the droplet target DL reaches the plasma generation region AR at the target velocity. That is, in the present step, the processor 121 controls the velocity of the combined droplet target DL. Accordingly, the droplet target DL is supplied from the nozzle 42 to the plasma generation region AR at a predetermined velocity and a predetermined frequency. After regulating the pressure in the tank 41, the processor 121 advances the control flow to step SP13.

(Step SP13) In the present step, the processor 121 calculates the delay time based on the velocity of the droplet target DL calculated in step SP12 and the distance from the first detection position P1 to the second detection position P2, and sets the calculated delay time in the delay circuit 122. The distance is a design distance designed in advance. After setting the delay time as a fixed value in the delay circuit 122, the processor 121 advances the control flow to step SP14.

(Step SP14) In the present step, the processor 121 individually outputs the light emission trigger signal via the delay circuit 122 in accordance with each of the passage timing signals recognized after the mask processing. Then, the light emission trigger signal is input to the laser device LD with a delay of the delay time set in the delay circuit 122 in step SP13. Each time the light emission trigger signal is input, the laser device LD outputs the laser light 90 and irradiates the droplet target DL with the laser light 90 at the second detection position P2. The laser light 90 is radiated to the droplet target DL at the second detection position P2 through the laser light delivery optical system 30 and the laser light concentrating optical system 13. This droplet target DL is the droplet target DL corresponding to the passage timing signal recognized through the mask processing. Here, the processor 121 controls the laser light manipulator 13C of the laser light concentrating optical system 13 so that the laser light 90 is concentrated in the plasma generation region AR.

Further, in the present step, as described above, the processor 121 individually outputs the imaging trigger signal via the delay circuit 122 in accordance with each of the plurality of passage timing signals recognized after the mask processing. As a result, the imaging device 500 can image, at the second detection position P2, the droplet target DL which has been detected by the detection device 400 to pass through the first detection position P1 and has become the measurement target through the mask processing of the processor 121.

After outputting the light emission trigger signal and the imaging trigger signal, the processor 121 advances the control flow to step SP15.

(Step SP15) In the present step, when the droplet target DL is irradiated with the laser light 90 in the plasma generation region AR, plasma is generated by the irradiation, and light including the EUV light 101 is generated from the plasma. Among the light including the EUV light 101 generated in the plasma generation region AR, the EUV light 101 is concentrated at the intermediate focal point IF by the EUV light concentrating mirror 75, and then, is incident on the exposure apparatus 200 from the connection portion 19.

Here, when the target substance is turned into plasma, tin fine particles are generated as described above. The fine particles diffuse to the internal space of the chamber 10. The fine particles diffusing to the internal space of the chamber 10 react with the hydrogen-containing etching gas supplied from the central gas supply unit 81 to become stannane. Most of the stannane obtained through the reaction with the etching gas flows into the exhaust port 10E along with the flow of the unreacted etching gas. At least some of the unreacted charged particles, fine particles, and etching gas flow into the exhaust port 10E. The unreacted etching gas, fine particles, charged particles, stannane, and the like having flowed into the exhaust port 10E flow as residual gas through the exhaust pipe 10P into the exhaust pump 60 and are subjected to predetermined exhaust treatment such as detoxification.

When the EUV light 101 enters the exposure apparatus 200, the control flow proceeds to step SP16.

(Step SP16) In the present step, if a stop signal is not input from the exposure apparatus 200, the processor 121 returns the control flow to step SP14 to continue the generation of the EUV light 101, and if the stop signal is input, the processor 121 ends the control flow.

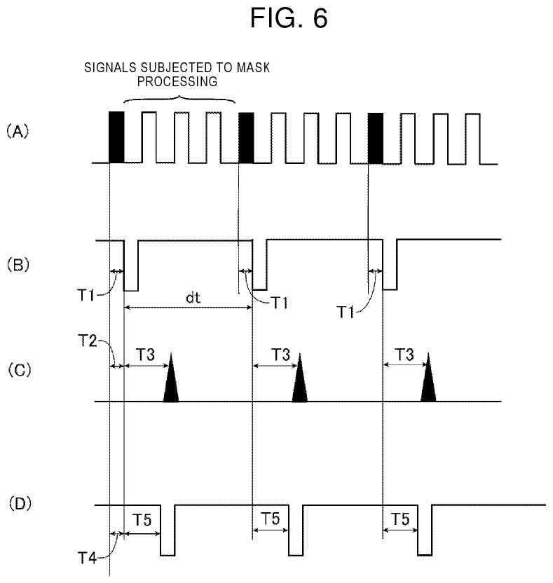

FIG. 6 is a timing chart of the control flowchart shown in FIG. 5. FIG. 6A is a diagram corresponding to step SP11 and showing a timing chart of generating the passage timing signal. As described above, the passage timing signal is generated for each of the droplet targets DL passing through the first detection position P1. The interval of the passage timing signals is constant. Black portions in FIG. 6 a are passage timing signals recognized after the mask processing, and the other portions are passage timing signals not recognized through the mask processing.

FIG. 6B is a diagram corresponding to step SP11 and showing a timing chart of generating the trigger signal. The trigger signal is generated based on the passage timing signal recognized through the mask processing and the delay time, and is the signal serving as a starting point of the light emission trigger signal and the imaging trigger signal as described above. In FIG. 6B, a time interval T1 indicates the delay time of the trigger signal synchronized with the passage timing signal, and a time interval dt indicates a time interval of the trigger signals, that is, a time interval of the combined droplet targets DL corresponding to the passage timing signals recognized through the mask processing.

FIG. 6C is a diagram corresponding to step SP14 and is a diagram showing a timing chart when the laser device LD irradiates the droplet target DL having reached the second detection position P2 with the laser light 90. In FIG. 6C, T2 indicates the time interval from the input of the passage timing signal to the processor 121 to the input of the light emission trigger signal to the laser device LD. The time interval T2 is the same as the time interval T1. Then, the laser light 90 travels from the laser device LD to the plasma generation region AR over a certain period of time having a fixed value and is radiated to the droplet target DL. In FIG. 6C, T3 indicates the time interval from the input of the light emission trigger signal to the laser device LD to the irradiation of the droplet target DL with the laser light 90.

FIG. 6D is a diagram corresponding to step SP14 and is a diagram showing a timing chart when the imaging device 500 images the droplet target DL having reached the second detection position P2. In FIG. 6D, 14 indicates the time interval from the input of the passage timing signal to the processor 121 to the input of the imaging trigger signal to the imaging device 500. The time interval T4 is the same as the time interval T1. Then, the light 94 reaches the imaging body unit 527 from the light source 513 over a certain period of time having a fixed value. In FIG. 6D, T5 indicates a time interval from the input of the imaging trigger signal to the imaging device 500 to imaging of the light 94 by the imaging body unit 527.

### 3.3 Problem

In the EUV light generation apparatus 100 of the comparative example, the delay time is calculated based on the velocity of the droplet target DL and the distance from the first detection position P1 to the second detection position P2, as described in step SP13. This distance is preferably a measurement distance actually measured after the detection device 400 and the imaging device 500 are installed in the chamber 10. However, since it is not easy to measure the measurement distance after the installation, a design distance designed in advance is used. That is, the delay time is calculated based on the velocity of the droplet target DL and the design distance from the first detection position P1 to the second detection position P2. When the EUV light generation apparatus 100 is assembled, the detection device 400 and the imaging device 500 may be deviated from preset installation positions in the chamber 10. Therefore, there may be a case that the distance from the first detection position P1 to the second detection position P2 is different from the design distance. In this case, the delay time may not be accurately calculated. As a result, there may be a case that the droplet target DL different from the droplet target DL assumed in advance is irradiated with the laser light 90. The different droplet target DL is a droplet target DL corresponding to the passage timing signal that is not recognized through the mask processing. Further, even when the assumed droplet target DL is irradiated with the laser light 90, the irradiation position on the droplet target DL may be deviated. Further, since the velocity of the droplet target DL slightly varies, even when the assumed droplet target DL is irradiated with the laser light 90, the irradiation position on the droplet target DL may be deviated. As a result, the EUV light 101 that satisfies the performance required by the exposure apparatus 200 or the inspection apparatus 300 may not be output, and the reliability of the EUV light generation apparatus 100 may decrease.

Therefore, in each of the following embodiments, the EUV light generation apparatus 100 capable of suppressing a decrease in reliability will be exemplified.

### 4. Description of Extreme Ultraviolet Light Generation Apparatus of First Embodiment

Next, the EUV light generation apparatus 100 of a first embodiment will be described. Any component same as that described above is denoted by an identical reference sign, and duplicate description thereof is omitted unless specific description is needed.

### 4.1 Configuration

The configuration of the EUV light generation apparatus 100 of the present embodiment is similar to the configuration of the EUV light generation apparatus 100 of the comparative embodiment, and therefore description thereof is omitted.

### 4.2 Operation

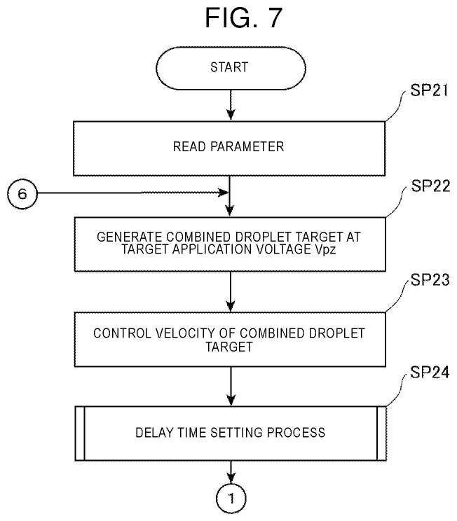

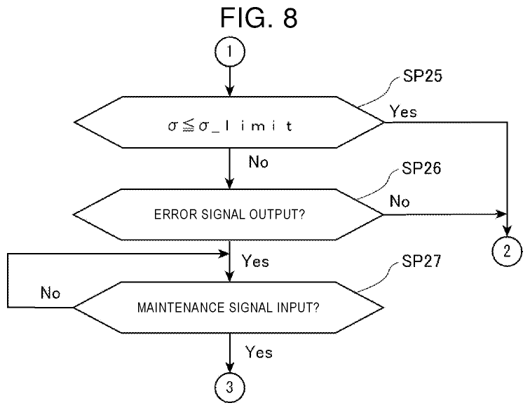

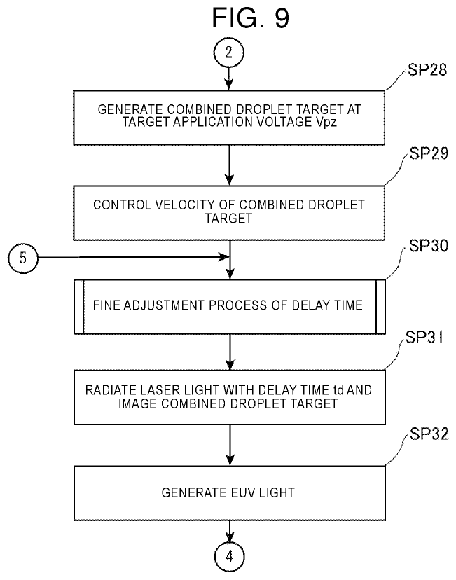

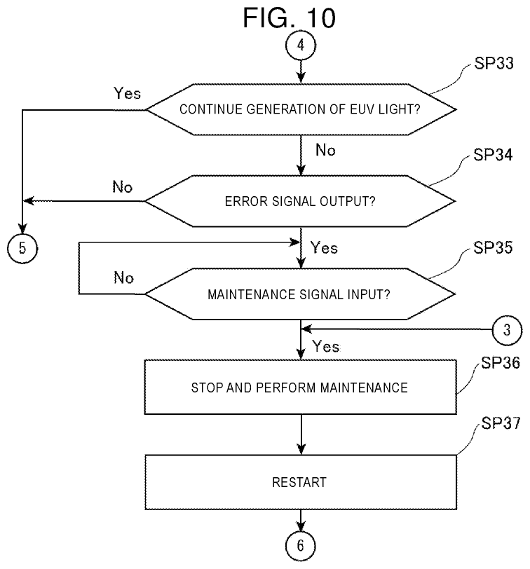

Next, operation of the processor 121 of the present embodiment will be described. FIG. 7 is a diagram showing a part of a control flowchart of the processor 121 of the present embodiment. FIGS. 8 and 9 are diagrams each showing another part of the control flowchart. FIG. 10 is a diagram showing a remaining part of the control flowchart. The control flowchart of the present embodiment includes steps SP21 to SP37.

In the start state shown in FIG. 7, the processor 121 receives a drive instruction signal for the target supply unit 40 from the exposure processor of the exposure apparatus 200. In addition, in the start state, the processor 121 causes the light 92 to be output from the illumination unit 410 and the light 94 to be output from the illumination unit 510. In the start state, similarly to the comparative example, the processor 121 completes preparation for outputting the droplet target DL, such as melting the target substance in the tank 41. In the present embodiment, a delay time setting process uses the non-combined droplet target DL different from the combined droplet target DL having the interval to the adjacent droplet target DL described in the comparative example substantially constant. The non-combined droplet target DL has an irregular interval to the adjacent droplet target DL.

(Step SP21) The steps from the present step to step SP27 are preparation steps prior to the full operation of the EUV light generation apparatus 100. In the present step, the processor 121 reads parameters from the storage device. The parameters of the present embodiment include a target application voltage Vpz of the piezoelectric element 47, a reference delay time td0, an upper limit delay time td_upper_limit, a lower limit delay time td_lower_limit, a threshold d_limit, a target number n_target for the number n of pieces of image data of the non-combined droplet target DL, and a threshold σ_limit.

The target application voltage Vpz is a voltage at which the combined droplet target DL is output by the vibration of the piezoelectric element 47 to which the voltage is applied. The reference delay time td0 is a time calculated from the design distance between the first detection position P1 and the second detection position P2 and the theoretical velocity of the combined droplet target DL. The theoretical velocity of the combined droplet target DL has a value obtained by dividing the interval between the adjacent combined droplet targets DL obtained from the image data imaged in advance by the generation frequency of the combined droplet targets DL. The upper limit delay time td_upper_limit is an upper threshold of the delay time, and the lower limit delay time td_lower_limit is a lower threshold of the delay time. The threshold d_limit is a threshold of the distance from the second detection position P2 to the combined droplet target DL. The threshold σ_limit is a threshold of the standard deviation σ of the variation of the non-combined droplet targets DL with respect to the second detection position P2. The threshold σ_limit may be 3σ. After reading the various parameters, the processor 121 advances the control flow to step SP22.

(Step SP22) In the present step, similarly to step SP11, the processor 121 controls the pressure regulator 43 to regulate the pressure in the tank 41 and causes the target substance in the tank 41 to be output into the chamber 10 through the nozzle hole of the nozzle 42. At this time, unlike the comparative example, the processor 121 applies the target application voltage Vpz from the piezoelectric power source 48 to the piezoelectric element 47. Thus, the piezoelectric element 47 vibrates at a predetermined frequency. Therefore, in the present step, the processor 121 drives the piezoelectric element 47 to generate and output the combined droplet target DL. That is, the interval between the adjacent droplet targets DL is substantially constant. After outputting the droplet target DL as the combined droplet target DL, the processor 121 advances the control flow to step SP23.

Prior to step SP23, when the droplet target DL passes through the first detection position P1, the detection device 400 outputs the passage timing signal as an electric signal to the processor 121, as in the comparative example. The detection device 400 outputs the passage timing signal for each of the droplet targets DL passing through the first detection position P1. The processor 121 performs mask processing on the plurality of input passage timing signals and recognizes only specific passage timing signals. Further, the processor 121 outputs the imaging trigger signal to each of the shutter 525 and the imaging body unit 527 via the delay circuit 122 with a delay of the reference delay time td0 from the input of the passage timing signal recognized after the mask processing. As a result, the shutter 525 is opened, and the imaging body unit 527 images the droplet target DL located in the imaging region including the second detection position P2. Then, the imaging body unit 527 generates image data of the imaging region and the droplet target DL located in the imaging region. The imaging body unit 527 outputs the generated image data as an electric signal to the processor 121. Further, the processor 121 also outputs the imaging trigger signal individually in accordance with each of the plurality of passage timing signals recognized after the mask processing. Thus, each time the imaging trigger signal is input, the imaging body unit 527 performs imaging and generates and outputs the image data.

(Step SP23) In the present step, similarly to step SP12, the processor 121 calculates the target velocity of the combined droplet target DL from the frequency of the piezoelectric element 47 and the interval between the combined droplet targets DL, and controls the velocity of the combined droplet target DL. Then, the processor 121 advances the control flow to step SP24.

(Step SP24) In the present step, the processor 121 proceeds to the delay time setting process described later. In the delay time setting process, the standard deviation σ of the variation of the non-combined droplet targets DL with respect to the second detection position P2 is calculated. The standard deviation σ will be described in detail in the delay time setting process. Then, the delay time is calculated based on the standard deviation σ, and the calculated delay time is set in the delay circuit 122. After the delay time is set and the delay time setting process is completed, the processor 121 advances the control flow to step SP25 shown in FIG. 8.

Next, steps SP25 to SP27 will be described with reference to FIG. 8.

(Step SP25) In the present step, the processor 121 advances the control flow to step SP28 shown in FIG. 9 when the standard deviation σ is equal to or less than the threshold σ_limit described in step SP21, and advances the control flow to step SP26 when the standard deviation σ is more than the threshold σ_limit.

(Step SP26) In the present step, the processor 121 advances the control flow to step SP28 shown in FIG. 9 when an error signal is not to be output to the exposure apparatus 200, and advances the control flow to step SP27 when the error signal is to be output to the exposure apparatus 200. Whether or not the error signal needs to be output is determined based on a criterion determined in advance by the exposure apparatus 200. When the standard deviation σ in step SP24 is important for the exposure apparatus 200, the processor 121 outputs the error signal, and when the standard deviation σ is not important for the exposure apparatus 200, the processor 121 does not output the error signal.

(Step SP27) In the present step, the processor 121 waits when a maintenance signal is not input from the exposure apparatus 200, and advances the control flow to step SP36 shown in FIG. 10 when the maintenance signal is input.

Next, steps SP28 to SP32 will be described with reference to FIG. 9. Step SP28 and the subsequent steps are steps for the full operation of the EUV light generation apparatus 100.

(Step SP28) In the present step, similarly to step SP22, the processor 121 applies the target application voltage Vpz to the piezoelectric element 47 to generate and output the droplet target DL as the combined droplet target DL, and advances the control flow to step SP29.

Here, when the droplet target DL passes through the first detection position P1, the detection device 400 outputs the passage timing signal to the processor 121, as in the comparative example. The detection device 400 outputs the passage timing signal for each of the droplet targets DL passing through the first detection position P1. The processor 121 performs mask processing on the plurality of input passage timing signals and recognizes only specific passage timing signals. Further, the processor 121 outputs the imaging trigger signal to each of the shutter 525 and the imaging body unit 527 via the delay circuit 122 with a delay of the delay time td from the input of the passage timing signal recognized after the mask processing. Each time the imaging trigger signal is input, the imaging body unit 527 performs imaging and generates and outputs the image data.

(Step SP29) In the present step, similarly to step SP23, the processor 121 calculates the target velocity of the droplet target DL from the frequency of the piezoelectric element 47 and the interval between the droplet targets DL, and controls the velocity of the combined droplet target DL. Then, the processor 121 advances the control flow to step SP30.

(Step SP30) In the present step, the processor 121 performs a fine adjustment process of the delay time to be described later, and advances the control flow to step SP31.

(Step SP31) In the present step, the processor 121 outputs the light emission trigger signal to the laser device LD via the delay circuit 122. The light emission trigger signal is input to the laser device LD with a delay time after the passage timing signal is input to the processor 121 according to the delay time finely adjusted in step SP30. When the light emission trigger signal is input, the laser device LD outputs the laser light 90. The laser light 90 is radiated to the droplet target DL at the plasma generation region AR through the laser light delivery optical system 30 and the laser light concentrating optical system 13.

Further, in the present step, when the passage timing signal is input from the detection device 400, the processor 121 outputs an imaging trigger signal to each of the shutter 525 and the imaging body unit 527 via the delay circuit 122 with a delay of the delay time from the input of the passage timing signal. As a result, the imaging device 500 can image the droplet target DL which has been detected by the detection device 400 to pass through the first detection position P1 and has become the measurement target through the mask processing of the processor 121.

After outputting the light emission trigger signal and the imaging trigger signal, the processor 121 advances the control flow to step SP32.

(Step SP32) In the present step, similarly to step SP15, when the droplet target DL is irradiated with the laser light 90 in the plasma generation region AR, light including the EUV light 101 is emitted. The EUV light 101 is concentrated at the intermediate focal point IF by the EUV light concentrating mirror 75, and then, is incident on the exposure apparatus 200 from the connection portion 19. When the EUV light 101 enters the exposure apparatus 200, the control flow proceeds to step SP33 shown in FIG. 10.

Next, steps SP33 to SP37 will be described with reference to FIG. 10. Step SP33 to Step SP37 are steps in which the EUV light generation apparatus 100 performs the full operation based on the EUV output signal from the exposure apparatus 200.

(Step SP33) In the present step, the processor 121 returns the control flow to step SP30 to continue the generation of the EUV light 101 when the stop signal is not input from the exposure apparatus 200 or when the delay time does not deviate from a predetermined value. The processor 121 advances the control flow to step SP34 to stop the generation of the EUV light 101 when a stop signal is input from the exposure apparatus 200. Further, when the delay time deviates from the predetermined value, the processor 121 also advances the control flow to step SP34 to cause the exposure apparatus 200 to determine whether or not it is necessary to stop the generation of the EUV light 101.

(Step SP34) In the present step, similarly to step SP26, the processor 121 returns the control flow to step SP30 when the error signal is not to be output to the exposure apparatus 200, and advances the control flow to step SP35 when the error signal is to be output to the exposure apparatus 200. The processor 121 does not output the error signal when the delay time has a value that can be allowed by the exposure apparatus 200, and outputs the error signal when the stop signal is input from the exposure apparatus 200 or when the delay time has a value that cannot be allowed by the exposure apparatus 200.

(Step SP35) In the present step, the processor 121 waits when the maintenance signal is not input from the exposure apparatus 200 after outputting the error signal, and advances the control flow to step SP36 when the maintenance signal is input.

(Step SP36) In the present step, the processor 121 stops the operation of the EUV light generation apparatus 100, and maintenance of the EUV light generation apparatus 100 is performed. When the maintenance of the EUV light generation apparatus 100 is finished, the control flow proceeds to step SP37.

(Step SP37) In the present step, the processor 121 restarts the EUV light generation apparatus 100 and returns the control flow to step SP22.

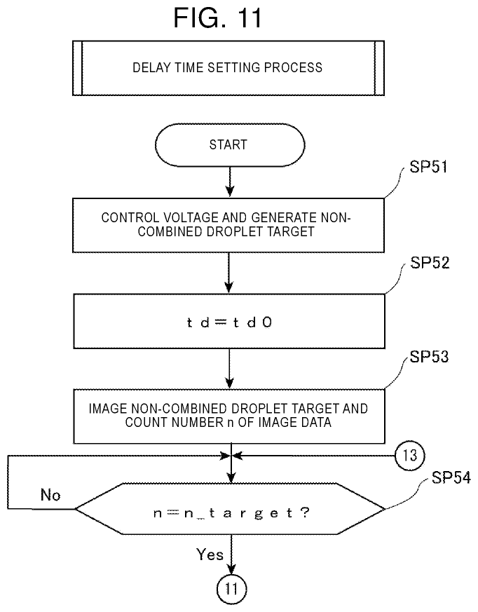

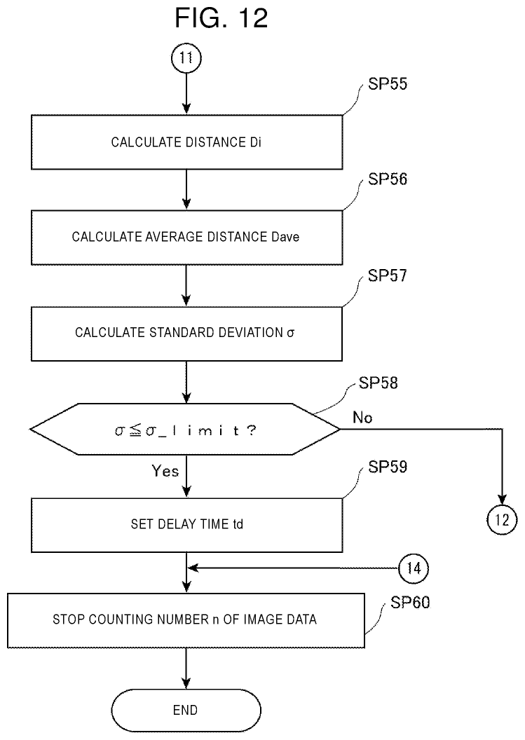

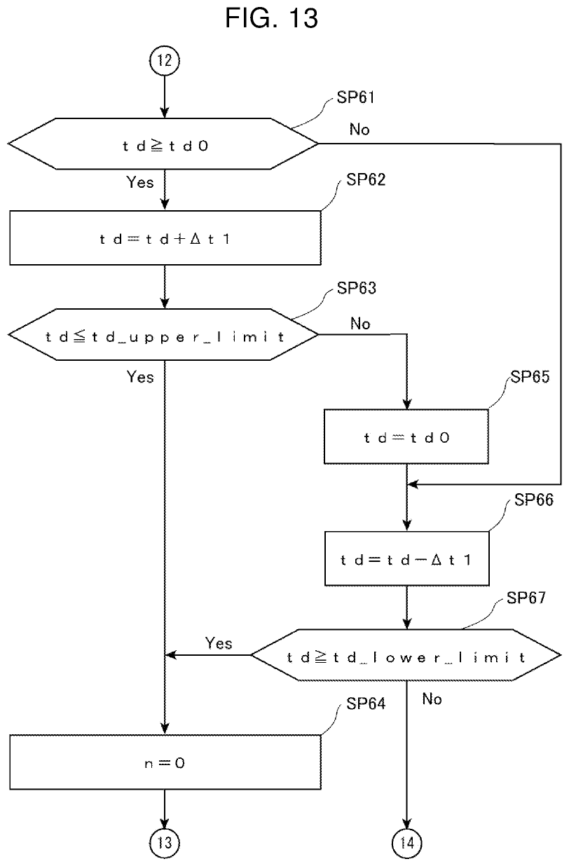

Next, the delay time setting process of the present embodiment in step SP22 will be described with reference to FIGS. 11, 12, and 13. FIG. 11 is a part of the control flowchart of the processor 121 in the delay time setting process of the present embodiment in step SP22. FIG. 12 is another part of the control flowchart. FIG. 13 is a remaining part of the control flowchart. The control flowchart of the present embodiment includes steps SP51 to SP67.

First, steps SP51 to SP54 will be described with reference to FIG. 11. Steps SP51 to SP54 are preparation steps prior to the full operation of the EUV light generation apparatus 100.

(Step SP51) In the present step, the processor 121 controls the voltage to be applied to the piezoelectric element 47 so that the non-combined droplet targets DL having irregular intervals between the adjacent droplet targets DL are generated. In the present embodiment, the processor 121 changes the voltage to be applied to the piezoelectric element 47 from the target application voltage Vpz described in step SP22 to 0 V. As a result, since the piezoelectric element 47 stops not to vibrate, the frequency of the piezoelectric element 47 is controlled to 0. When the droplet target DL is output in this state, the intervals between the adjacent droplet targets DL are changed from the substantially constant intervals described in step SP22 to the irregular intervals. Therefore, the droplet target DL is output as a non-combined droplet target DL. Since the pressure in the tank 41 is regulated by the pressure regulator 43, the velocity of the output non-combined droplet target DL is substantially constant. After outputting the droplet target DL as the non-combined droplet target DL, the processor 121 advances the control flow to step SP52.

(Step SP52) In the present step, the processor 121 sets the delay time td to the reference delay time td0. The reference delay time td0 in this step is not the reference delay time td0 in step SP21 but calculated from the design distance from the first detection position P1 to the second detection position P2 and the velocity of the droplet target DL calculated in step SP23. After setting the delay time td to the reference delay time td0, the processor 121 advances the control flow to step SP53.

Prior to step SP53, when the non-combined droplet target DL passes through the first detection position P1, the detection device 400 outputs the passage timing signal to the processor 121, as in the comparative example. The detection device 400 outputs the passage timing signal for each of the non-combined droplet targets DL passing through the first detection position P1. The processor 121 performs the mask processing on the plurality of input passage timing signals and recognizes only specific passage timing signals. The processor 121 outputs the imaging trigger signal to each of the shutter 525 and the imaging body unit 527 via the delay circuit 122 with a delay of the delay time from the input of the passage timing signal recognized after the mask processing.

(Step SP53) In the present step, the processor 121 also outputs the imaging trigger signal individually in accordance with each of the plurality of passage timing signals recognized after the mask processing. Therefore, a plurality of the imaging trigger signals are input to the imaging body unit 527, and the imaging body unit 527 performs imaging each time the imaging trigger signal is input. Thus, plural pieces of the image data are generated. The processor 121 counts the number n of the pieces of image data in which the non-combined droplet target DL is located in the imaging region of the imaging device 500 including the second detection position P2. Since the image data of the non-combined droplet target DL is sequentially input to the processor 121, the plural pieces of image data are input to the processor 121. When the processor 121 starts counting the number n of the pieces of image data, the control flow proceeds to step SP54.

(Step SP54) In the present step, the processor 121 returns the control flow to step SP54 and continues counting the number n of the pieces of image data when the number n of the pieces of image data of the non-combined droplet target DL does not reach the target number n_target described in step SP21. When the number n of the pieces of image data reaches the target number n_target, the processor 121 advances the control flow to step SP55 shown in FIG. 12. The target number n_target is 2 or more.

Next, steps SP55 to SP60 will be described with reference to FIG. 12. Steps SP55 to SP60 are preparation steps prior to the full operation of the EUV light generation apparatus 100.

(Step SP55) In the present step, the processor 121 calculates a distance Di from the second detection position P2 to the non-combined droplet target DL in each of the plural pieces of image data. The distance Di is a distance from the second detection position P2 to the non-combined droplet target DL closest to the second detection position P2. Since the distance Di is calculated for each of the plural pieces of image data, a plurality of distances Di are calculated. The coordinate of the second detection position P2 is specified in the image data. When a plurality of non-combined droplet targets DL exist in the image data, the non-combined droplet target DL closest to the second detection position P2 is used as described above. After calculating the plurality of distances Di, the processor 121 advances the control flow to step SP56.

(Step SP56) In the present step, the processor 121 calculates an average distance Dave of the plurality of calculated distances Di, and advances the control flow to step SP57.

(Step SP57) In the present step, the processor 121 calculates the standard deviation σ of the variation of the non-combined droplet target DL with respect to the second detection position P2 by substituting the number n of the pieces of image data, the distance Di, and the average distance Dave into the following expression (1). After calculating the standard deviation σ, the processor 121 advances the control flow to step SP58.

$$σ = \sqrt{\frac{1}{n} {\sum }_{i = 1}^{n} {( Di - Dave )}^{2}} \qquad ( 1 )$$

(Step SP58) In the present step, the processor 121 advances the control flow to step SP59 when the standard deviation σ is equal to or less than the threshold σ_limit described in step SP21, and advances the control flow to step SP61 shown in FIG. 13 when the standard deviation σ is more than the threshold σ_limit.

Next, steps SP61 to SP67 will be described with reference to FIG. 13. Steps SP61 to SP67 are preparation steps prior to the full operation of the EUV light generation apparatus 100.

(Step SP61) In the present step, the processor 121 advances the control flow to step SP62 when the current delay time td is equal to or more than the reference delay time td0 in step SP52, and advances the control flow to step SP66 when the current delay time td is less than the reference delay time td0.

(Step SP62) In the present step, the processor 121 sets, as the delay time td, a value obtained by adding a change time Δt1 of the delay time to the delay time td, and advances the control flow to step SP63. At this time, the processor 121 sets the change time Δt1 to a time equal to or less than the generation cycle of the combined droplet target DL while the piezoelectric element 47 is driven. The change time Δt1 may be an arbitrary time.

(Step SP63) In the present step, the processor 121 advances the control flow to step SP64 when the delay time td set in step SP62 is equal to or less than the upper limit delay time td_upper_limit in step SP21. Further, the processor 121 advances the control flow to step SP65 when the delay time td is more than the upper delay time td_upper_limit. The upper limit delay time td_upper_limit is calculated in advance from an error in the design distance between the first detection position P1 and the second detection position P2 and a design error in the velocity of the combined droplet target DL.

(Step SP64) In the present step, the processor 121 resets the number n of the pieces of image data to 0, and returns the control flow to step SP54. Since the number n of the pieces of image data is 0, the control flow proceeds from step SP54 to steps SP55, SP56, and SP57 sequentially. Then, using the delay time td set in steps SP62 and SP64, the standard deviation σ is calculated again in step SP57, and in step SP58, it is determined whether or not the standard deviation σ is more than the threshold σ_limit. As described above, by repeating the control flow of steps SP54 to SP58 and each step shown in FIG. 13, the processor 121 specifies the non-combined droplet target DL with which the standard deviation σ is equal to or less than the first threshold being the threshold σ_limit.

(Step SP65) In the present step, the processor 121 sets the delay time td to the reference delay time td0 in step SP52, and advances the control flow to step SP66.

(Step SP66) In the present step, the processor 121 sets, as the delay time td, a value obtained by subtracting the change time Δt1 of the delay time from the delay time td, and advances the control flow to step SP67.

(Step SP67) In the present step, the processor 121 advances the control flow to step SP64 when the delay time td set in step SP66 is equal to or more than the lower limit delay time td_lower_limit in step SP21. The lower limit delay time td_lower_limit is calculated in advance from the error in the design distance between the first detection position P1 and the second detection position P2 and the design error in the velocity of the combined droplet target DL. In step SP64, the processor 121 resets the number n of the pieces of image data to 0, and returns the control flow to step SP54. Since the number n of the pieces of image data is 0, the control flow proceeds from step SP54 to steps SP55, SP56, and SP57 sequentially. Then, using the delay time td set in step SP66, the standard deviation σ is calculated again in step SP57, and in step SP58, it is determined whether or not the standard deviation σ is more than the threshold σ_limit. Thus, when the control flow of steps SP54 to SP58, steps SP61 to SP63, steps SP65 to SP67, and step SP64 is repeated, the processor 121 specifies the non-combined droplet target DL with which the standard deviation σ is equal to or less than the first threshold being the reference value σ_limit.

Further, in the present step, the processor 121 advances the control flow to step SP60 shown in FIG. 12 when the delay time td is less than the upper delay time td_upper_limit. When the control flow proceeds from step SP67 to step SP60, the delay time td will not be more than the lower limit delay time td_lower_limit and equal to or less than the upper limit delay time td_upper_limit, and the non-combined droplet target DL will not be recognized. As a result, the delay time setting process ends.

(Step SP59) The control flow returns from step SP64 to step SP54 through steps SP54 to SP58 and through steps SP61 to SP67. Thus, the delay time td is equal to or more than the lower limit delay time td_lower_limit, and equal to or less than the upper limit delay time td_upper_limit. In the present step, the processor 121 sets, as the delay time td, a value obtained by adding the change time Δt corresponding to the average distance Dave to the delay time td. The change time Δt is obtained by dividing the average distance Dave calculated in step SP56 by the velocity of the droplet target DL calculated in step SP23. When the delay time td is set, the specified non-combined droplet target DL is located at the second detection position P2. Therefore, the processor 121 sets the delay time td based on the average distance Dave from the specified non-combined droplet target DL to the second detection position P2 with which the standard deviation σ calculated in step SP57 is equal to or less than the first threshold, so that the specified non-combined droplet target DL is located at the second detection position P2. After setting the delay time td, the processor 121 advances the control flow to step SP60.

(Step SP60) In the present step, the processor 121 stops the imaging of the non-combined droplet target DL by the imaging device 500 and stops counting the number n of the pieces of image data. Then, the processor 121 ends the delay time setting process and advances the control flow to step SP25.

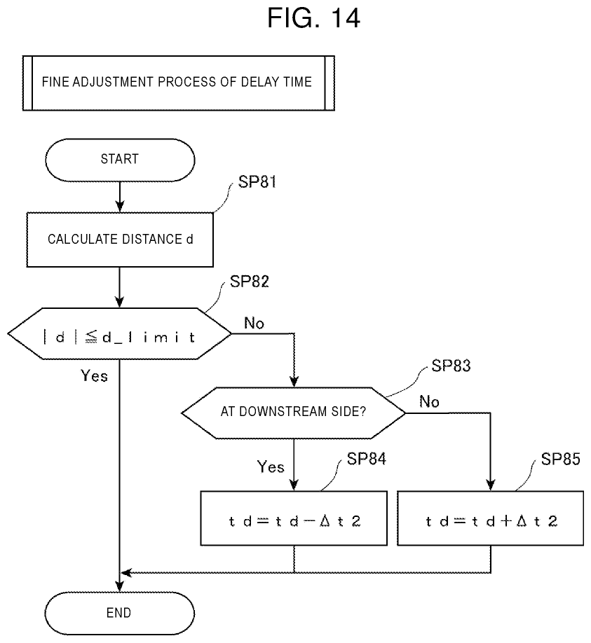

FIG. 14 is a control flowchart of the processor 121 in the fine adjustment process of the delay time in step SP30. The control flowchart of the present embodiment includes steps SP81 to SP85. Even after the delay time is set in the delay time setting process of step SP24, the position of the droplet target DL may be deviated in the travel direction of the droplet target DL due to a minute variation in the velocity of the droplet target DL. In order to correct this deviation, the delay time is finely adjusted according to the deviation in the present flowchart.

(Step SP81) In the present step, the processor 121 calculates the distance d from the second detection position P2 to the combined droplet target DL from the image data imaged in step SP28. When a plurality of the combined droplet targets DL exist in the image data, the processor 121 calculates the distance d from the second detection position P2 to the combined droplet target DL closest to the second detection position P2. The coordinate of the second detection position P2 is specified in the image data. After calculating the distance d, the processor 121 advances the control flow to step SP82.

(Step SP82) In the present step, when the absolute value of the distance d is equal to or less than a second threshold being the threshold d_limit in step SP21, the processor 121 ends the fine adjustment process of the delay time, and advances the control flow to step SP31. When the absolute distance d is more than d_limit, the processor 121 advances the control flow to step SP83.

(Step SP83) In the present step, when the combined droplet target DL is located downstream of the second detection position P2 in the travel direction of the combined droplet target DL, the processor 121 advances the control flow to step SP84. Further, when the combined droplet target DL is located upstream of the second detection position P2 in the travel direction of the combined droplet target DL, the processor 121 advances the control flow to step SP85.

(Step SP84) In the present step, the processor 121 sets, as the delay time td, a value obtained by subtracting the re-change time Δt2 of the delay time from the delay time td, ends the fine adjustment process of the delay time, and advances the control flow to step SP31. The re-change time Δt2 is a time less than the change time Δt1.

(Step SP85) In the present step, the processor 121 sets, as the delay time td, a value obtained by adding the re-change time Δt2 of the delay time to the delay time td, ends the fine adjustment process of the delay time, and advances the control flow to step SP31.

In steps SP84 and SP85, the processor 121 sets the re-change time Δt2 of the delay time to be less than the change time Δt1. Therefore, after setting the delay time td in the delay time setting process of step SP24, when the distance from the second detection position P2 to the combined droplet target DL in the imaging region is more than the second threshold in step SP82, the processor 121 resets the delay time td based on the re-change time Δt2 of the delay time less than the change time Δt1.

### 4.3 Effect

In the present embodiment, when the processor 121 controls the piezoelectric element 47 in step SP51, the non-combined droplet targets DL in which the intervals between the adjacent droplet targets DL are irregular are generated. Since the detection device 400 inputs the passage timing signal to the processor 121 each time the detection device 400 detects the passage of the non-combined droplet target DL at the first detection position P1, a plurality of the passage timing signals are input to the processor 121. The processor 121 performs mask processing on the plurality of passage timing signals and outputs an imaging trigger signal to the imaging device 500 for each of the passage timing signals recognized after the mask processing. Each time the imaging trigger signal is input to the imaging device 500, the imaging device 500 images the non-combined droplet target DL located in the imaging region including the second detection position P2 and generates the image data of the imaging region and the non-combined droplet target DL located in the imaging region. Since the imaging device 500 generates the image data each time the imaging trigger signal is input, plural pieces of the image data are generated. Here, the velocity of the non-combined droplet target DL output from the nozzle 42 is substantially constant. Therefore, each of the non-combined droplet targets DL having irregular intervals other than the non-combined droplet targets DL corresponding to the passage timing signals recognized through the mask processing is not synchronized with the imaging timing of the imaging device 500 and tends to deviate from the second detection position P2. When the plural pieces of image data are compared with each other, each of the non-combined droplet targets DL that is not synchronized with the imaging timing of the imaging device 500 has a positional variation with respect to the second detection position P2. Then, the processor 121 calculates the standard deviation σ of the distance from the second detection position P2 to the non-combined droplet target DL from the plural pieces of image data in step SP57, and specifies the non-combined droplet target DL in which the calculated standard deviation σ is less than the threshold σ_limit being the first threshold. Further, in step SP59, the processor 121 sets the delay time td to the delay circuit 122 based on the average distance Dave from the position of the non-combined droplet target DL to the second detection position P2 so that the specified non-combined droplet target DL is located at the second detection position P2. When the processor 121 sets the delay time td, the delay circuit 122 outputs the light emission trigger signal at a timing delayed by the delay time td with respect to each of the passage timing signals recognized after the mask processing. Thus, the laser light 90 can be radiated to the previously assumed combined droplet target DL, that is, the combined droplet target DL corresponding to the passage timing signal recognized through the mask processing, and the deviation of the irradiation position on the droplet target DL can be suppressed. Therefore, even when the detection device 400 and the imaging device 500 deviate from the installation positions set in advance in the chamber 10, the irradiation with the laser light 90 to a droplet target DL different from the droplet target DL assumed in advance can be suppressed, and the deviation of the irradiation position on the combined droplet target DL assumed in advance can be suppressed. Further, even when the velocity of the droplet target DL slightly varies, the deviation of the irradiation position on the combined droplet target DL assumed in advance can be suppressed. Therefore, the laser light 90 that satisfies the performance required by the exposure apparatus 200 or the inspection apparatus 300 can be output, and a decrease in reliability of the EUV light generation apparatus 100 can be suppressed.

Further, the processor 121 controls the frequency of the piezoelectric element 47 serving as the vibrating element to 0 in step SP51. According to this configuration, since the piezoelectric element 47 does not vibrate, it is possible to generate the non-combined droplet targets DL in which the interval between the adjacent droplet targets DL is irregular.

Further, when the processor 121 cannot specify the non-combined droplet target DL having the standard deviation σ equal to or less than the threshold σ_limit being the first threshold value in step SP58, in steps SP62 and SP65, the processor 121 changes the change time Δt1 of the delay time to a time equal to or less than the generation cycle of the droplet target DL in a case that the interval of the adjacent droplet targets DL is constant. Then, the processor 121 specifies the non-combined droplet target DL with which the standard deviation σ is less than the threshold σ_limit. According to this configuration, it is possible to specify the non-combined droplet target DL corresponding to the passage timing signal recognized through the mask processing and located in the imaging region at the time of imaging by the imaging device 500 within the range from the lower limit delay time td_lower_limit to the upper limit delay time td_upper_limit.

Further, after setting the delay time td in the delay time setting process of step SP24, when the distance from the second detection position P2 to the combined droplet target DL in the imaging region is more than the threshold d_limit being the second threshold value in step SP82, the processor 121 resets the delay time td based on the re-change time Δt2 of the delay time less than the change time Δt1. In this configuration, even when the droplet target DL is deviated from the second detection position P2 after the delay time td is changed, the delay time td is re-changed. Accordingly, it is possible to further suppress the laser light 90 from being radiated to the droplet target DL different from the droplet target DL detected by the detection device 400.

### 5. Description of Extreme Ultraviolet Light Generation Apparatus of Second Embodiment

Next, the EUV light generation apparatus 100 of a second embodiment will be described. Any component same as that described above is denoted by an identical reference sign, and duplicate description thereof is omitted unless specific description is needed.

### 5.1 Configuration

The configuration of the EUV light generation apparatus 100 of the present embodiment is similar to the configuration of the EUV light generation apparatus 100 of the comparative embodiment and the first embodiment, and therefore description thereof is omitted.

### 5.2 Operation

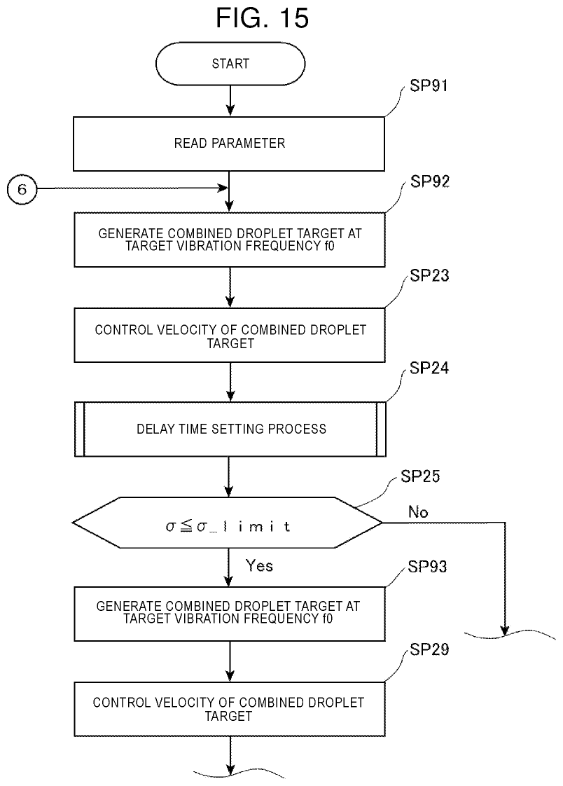

Next, operation of the processor 121 of the present embodiment will be described. FIG. 15 is a diagram showing a part of a control flowchart of the processor 121 of the present embodiment. The control flowchart of the present embodiment differs from the control flowchart of the first embodiment in that steps SP91, SP92, and SP93 are included instead of steps SP21, SP22, and SP28. Steps SP91, S92, and SP93 are preparation steps prior to the full operation of the EUV light generation apparatus 100.

The EUV light generation apparatus 100 of the first embodiment changes the voltage applied to the piezoelectric element 47 to 0 V to generate the non-combined droplet target DL. On the other hand, the EUV light generation apparatus 100 of the present embodiment generates the droplet target DL by irregularly changing the frequency of the voltage applied to the piezoelectric element 47. Since the interval between the adjacent droplet targets DL depends on the frequency of the piezoelectric element 47, by irregularly controlling the frequency of the voltage of the piezoelectric element 47, the frequency is irregularly controlled, and the combined droplet targets DL having artificially irregular intervals are generated.

(Step SP91) In the present step, the processor 121 reads parameters different from the parameters of the first embodiment from the storage device. The parameters of the present embodiment include a target vibration frequency f0 of the piezoelectric element 47, a vibration level number m of the piezoelectric element 47, an application voltage frequency fm of the piezoelectric element 47 at each vibration level number m, a target number nm_target of the pieces of image data of the non-combined droplet target DL to be acquired at each vibration level number m, the reference delay time td0, the upper limit delay time td_upper_limit, the lower limit delay time td_lower_limit, the threshold d_limit of the distance from the second detection position P2 to the combined droplet target DL, and the threshold σ_limit of the non-combined droplet target DL. The target vibration frequency f0 is the frequency at which the combined droplet targets DL are generated. The vibration level number m, the application voltage frequency fm, and the target number nm_target of the pieces of image data of the non-combined droplet target DL are associated with each other. Here, m is a natural number equal to or more than 1. The application voltage frequency fm has the value at which at least one non-combined droplet target DL is located in the imaging region. For example, when the imaging region has a length of 200 μm in the travel direction of the droplet target DL having the second detection position P2 as the center thereof, the application voltage frequency fm has a value at which the interval between the adjacent droplet targets DL is 200 μm or less. The application voltage frequency fm has a value obtained by dividing the theoretical velocity of the droplet target DL by the target interval between the adjacent droplet targets DL. After reading the various parameters, the processor 121 advances the control flow to step SP92.

(Steps SP92 and SP93) In the present steps, similarly to step SP22, the processor 121 controls the pressure regulator 43 to regulate the pressure in the tank 41 and causes the target substance in the tank 41 to be output into the chamber 10 through the nozzle hole of the nozzle 42. At this time, unlike step SP22, the processor 121 applies a voltage from the piezoelectric power source 48 to the piezoelectric element 47 so that the piezoelectric element 47 vibrates at the target vibration frequency f0 and the combined droplet target DL is generated and output by the vibration. Therefore, in the present step, as in step SP22, the processor 121 drives the piezoelectric element 47 to generate and output the combined droplet target DL. The processor 121 advances the control flow to step SP23 after step SP92 and to step SP29 after step SP93.

In this control flow, although not shown, the processor 121 returns the control flow to step SP92 after completing step SP37.

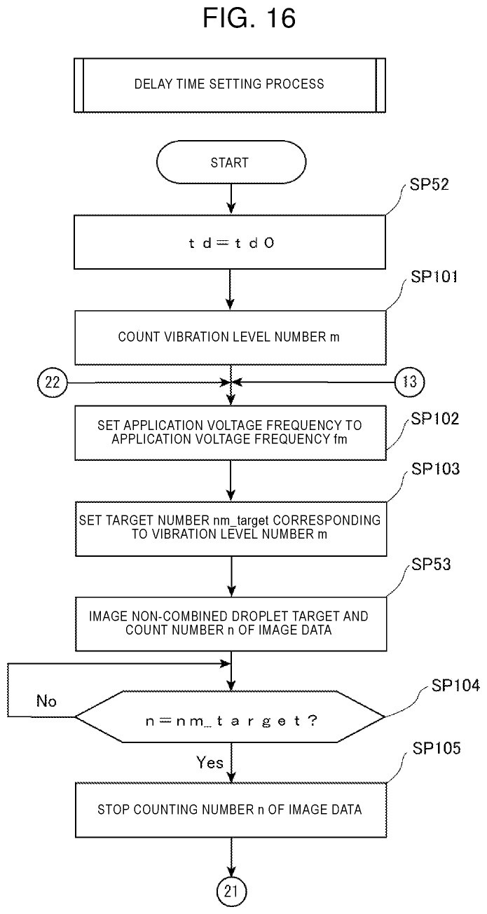

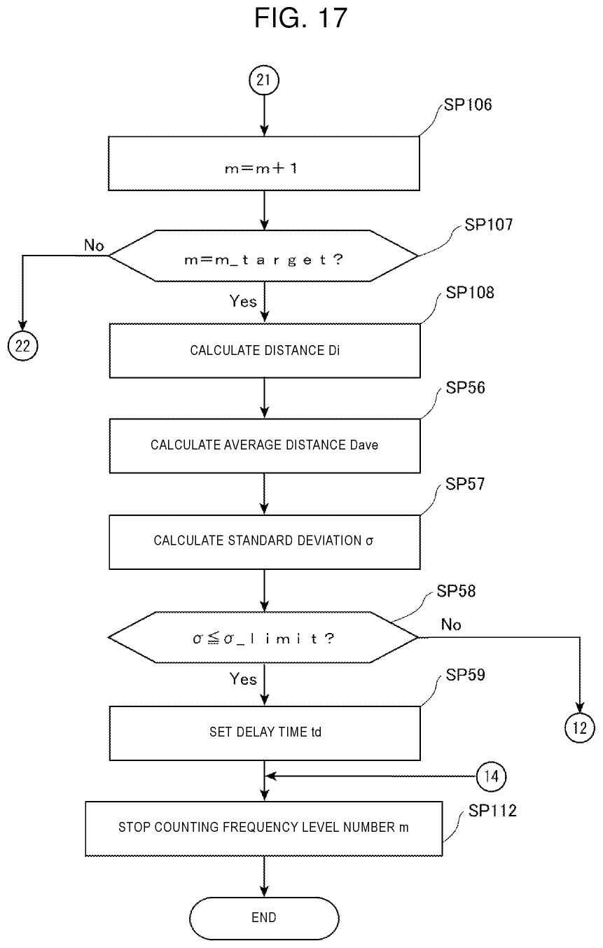

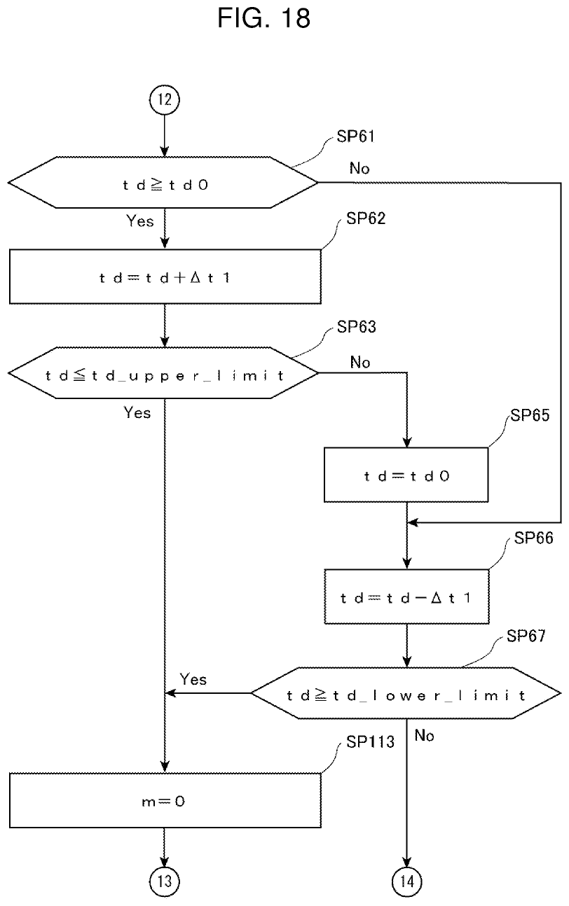

Further, in the present embodiment, the delay time setting process is different from that in the first embodiment. FIG. 16 is a part of the control flowchart of the processor 121 in the delay time setting process of the present embodiment. FIG. 17 is another part of the control flowchart. FIG. 18 is a remaining part of the control flowchart. The control flowchart of the present embodiment differs from the control flowchart of the first embodiment in that step SP51 is omitted and steps SP101 to SP103 are provided between step SP52 and step SP53. Further, the control flowchart differs from that of the first embodiment in that steps SP104 to SP108 are provided between step SP53 and step SP56 and step SP112 is provided instead of step SP60. Furthermore, the control flowchart differs from that of the first embodiment in that step SP113 is provided instead of step SP64. In the control flowchart of the present embodiment, the processor 121 advances the control flow to step SP52 after starting and to step SP101 after step SP52.

(Step SP101) In the present step, the processor 121 starts counting the vibration level number m of the piezoelectric element 47, and advances the control flow to step SP102. The initial value of the vibration level number m is 1.

(Step SP102) In the present step, the processor 121 sets the application voltage frequency of the piezoelectric element 47 to the application voltage frequency fm corresponding to the current vibration level number m of the piezoelectric element 47, and advances the control flow to step SP103. When the control flow advances to step SP102 for the first time, since the initial value of the vibration level number m is 1, the application voltage frequency becomes the application voltage frequency f1. When the application voltage frequency fm is set, the combined droplet target DL in which the interval between the adjacent droplet targets DL is different from that when the application voltage frequency f1 is set is output.

(Step SP103) In the present step, the processor 121 sets the target number of the pieces of image data of the non-combined droplet target DL to the target number nm_target corresponding to the current vibration level number m of the piezoelectric element 47, and advances the control flow sequentially to steps SP53 and SP104.

(Step SP104) In the present step, the processor 121 returns the control flow to step SP104 and continues counting the number n of the pieces of image data when the number n of the pieces of image data does not reach the target number nm_target set in step SP103. When the number n of the pieces of image data reaches the target number nm_target, the processor 121 advances the control flow to step SP105.

(Step SP105) In the present step, the processor 121 stops counting the number n of the pieces of image data and advances the control flow to step SP106 shown in FIG. 17.

Next, steps SP106 and thereafter will be described with reference to FIG. 17.

(Step SP106) In the present step, the processor 121 adds 1 to the vibration level number m of the piezoelectric element 47, sets the current vibration level number m of the piezoelectric element 47 to the vibration level number m+1, and advances the control flow to step SP107.

(Step SP107) In the present step, the processor 121 returns the control flow to step SP102 when the current vibration level number m of the piezoelectric element 47 does not reach the maximum value m_target of the vibration level number m. Further, the processor 121 advances the control flow to step SP108 when the current vibration level number m of the piezoelectric element 47 reaches the maximum value m_target.

(Step SP108) In the present step, the processor 121 calculates the distance Di from the second detection position P2 to the non-combined droplet target DL closest to the second detection position P2 in each of the plural pieces of image data at each vibration level number m. That is, the processor 121 calculates the distance Di in each of the plural pieces of image data at each of the application voltage frequencies f1 to fm. After calculating the distance Di, the processor 121 advances the control flow to step SP56.

(Step SP56) In the present step, the processor 121 calculates the average distance Dave of all the calculated distances Di. After calculating the average distance Dave, the processor 121 advances the control flow sequentially to steps SP57 and SP58. When the standard deviation σ is equal to or less than the threshold σ_limit in step SP58, the processor 121 advances the control flow sequentially to steps SP59 and SP112.

(Step SP112) In the present step, the processor 121 stops counting the vibration level number m of the piezoelectric element 47. Then, the processor 121 ends the delay time setting process and advances the control flow to step SP25.

Further, when the standard deviation σ is more than the threshold σ_limit in step SP58, the processor 121 advances the control flow to step SP61 shown in FIG. 18.

(Step SP113) As shown in FIG. 18, in the present step, the processor 121 resets the vibration level number m of the piezoelectric element 47 to 0, and returns the control flow to step SP102.

### 5.3 Effect

In the EUV light generation apparatus 100 of the present embodiment, the processor 121 irregularly controls the vibration frequency of the piezoelectric element 47 in step SP102. Since the interval between the adjacent droplet targets DL depends on the frequency of the piezoelectric element 47, according to this configuration, the combined droplet targets DL having different intervals between the adjacent droplet targets DL can be generated even when the piezoelectric element 47 is driven.

### 6. Description of Extreme Ultraviolet Light Generation Apparatus of Third Embodiment

Next, the EUV light generation apparatus 100 of a third embodiment will be described. Any component same as that described above is denoted by an identical reference sign, and duplicate description thereof is omitted unless specific description is needed.

The EUV light generation apparatus 100 of the first embodiment calculates the standard deviation σ based on the non-combined droplet target DL closest to the second detection position P2. On the other hand, the EUV light generation apparatus 100 of the present embodiment calculates the standard deviation σ based on all the non-combined droplet targets DL located in the image data.

### 6.1 Configuration

The configuration of the EUV light generation apparatus 100 of the present embodiment is similar to the configuration of the EUV light generation apparatus 100 of the comparative embodiment and the first and second embodiments, and therefore description thereof is omitted.

### 6.2 Operation

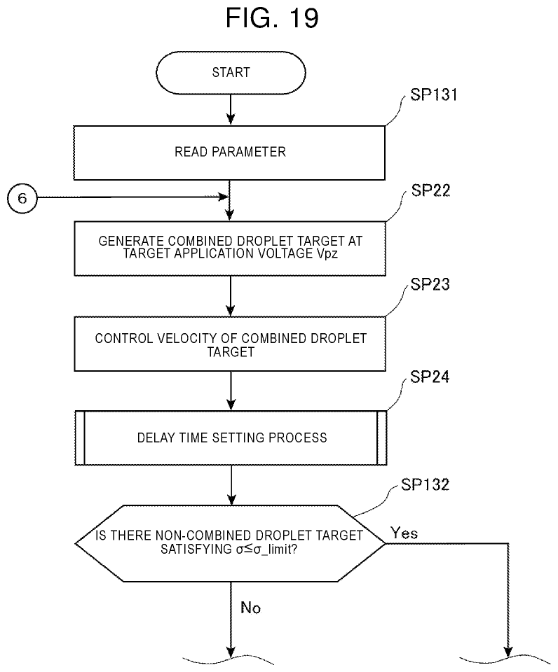

Next, operation of the processor 121 of the present embodiment will be described. FIG. 19 is a diagram showing a part of a control flowchart of the processor 121 of the present embodiment. As shown in FIG. 19, the control flowchart of the present embodiment differs from the control flowchart of the first embodiment in that steps SP131 and SP132 are included instead of steps SP21 and SP25. Steps S92 and SP132 are preparation steps prior to the full operation of the EUV light generation apparatus 100.

(Step SP131) In the present step, the processor 121 reads parameters different from the parameters of the first embodiment from the storage device. The parameters of the present embodiment include an initial width L0 of an observation region in the imaging region of the imaging body unit 527, a target width L1 of the observation region, and the parameters of the first embodiment. After reading the various parameters, the processor 121 advances the control flow to step SP22.

The observation region includes the second detection position P2. The initial width L0 and the target width L1 of the observation region are defined as lengths in the Y direction along the trajectory of the droplet target DL. In the delay time setting process of step SP24, to calculate the standard deviation σ, it is preferable that the initial width L0 is a size that allows one combined droplet target DL to exist in the observation region, for example, a length of 80% of the interval between the adjacent combined droplet targets DL. The target width L1 is more than the initial width L0 and is less than a value obtained by multiplying the time interval dt of the mask processing by the velocity of the combined droplet target DL. The target width L1 is a size that allows the plurality of non-combined droplet targets DL to exist in the observation region.

(Step SP132) In the present step, when there is no non-combined droplet target DL satisfying standard deviation σ≤threshold σ_limit, the processor 121 advances the control flow to step SP26 shown in FIG. 8. Further, when there is the non-combined droplet target DL satisfying standard deviation σ≤threshold σ_limit, the processor 121 advances the control flow to step SP28 shown in FIG. 9.

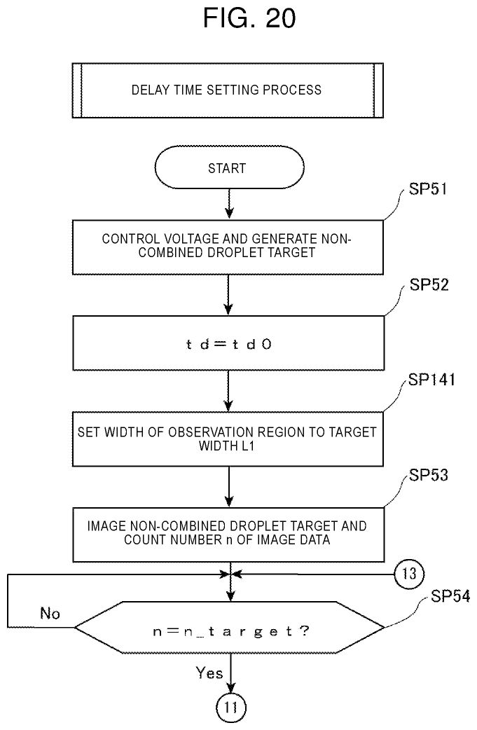

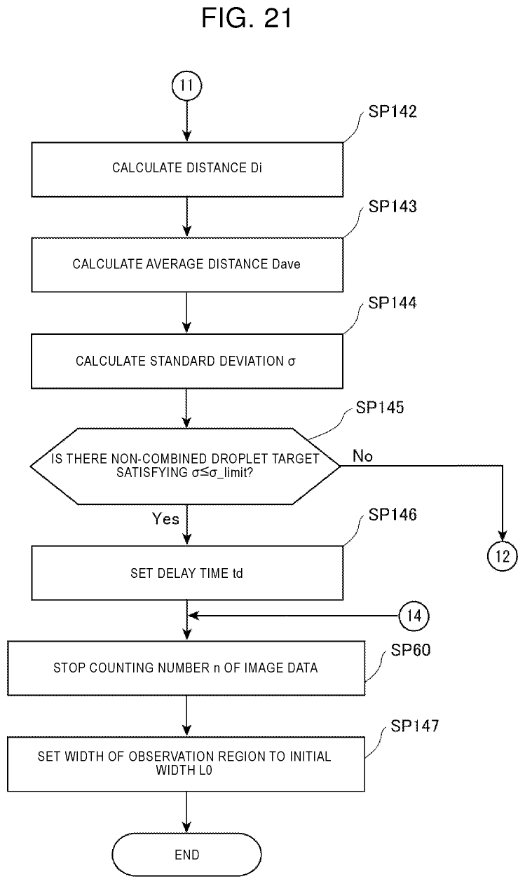

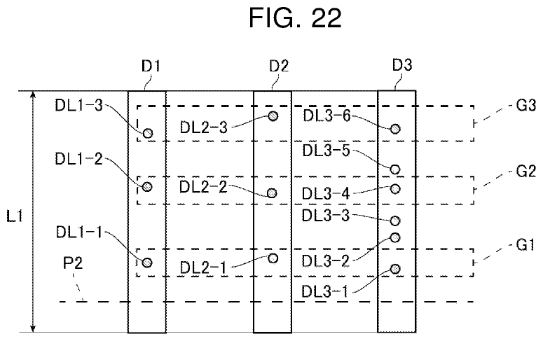

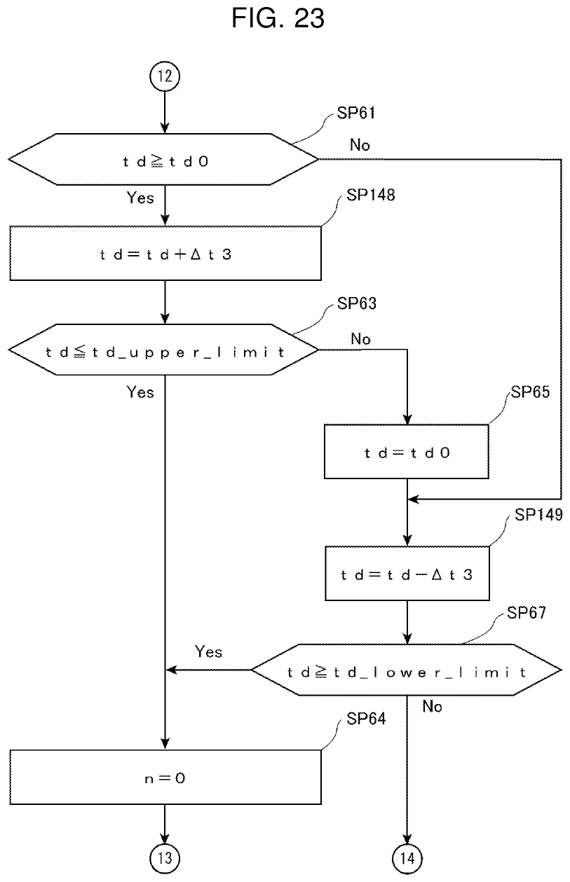

Further, in the present embodiment, the delay time setting process is different from that in the first embodiment. FIG. 20 is a part of the control flowchart of the processor 121 in the delay time setting process of the present embodiment. FIG. 21 is another part of the control flowchart. The control flowchart of the present embodiment differs in that step SP141 is included between step SP52 and step SP53 as shown in FIG. 20. Further, as shown in FIG. 21, the control flowchart of the present embodiment differs in that steps SP142 to SP146 are included instead of steps SP55 to SP59, and step SP147 is included after step SP60. FIG. 22 is a diagram for explaining the allocation in step SP143. FIG. 23 is a remaining part of the control flowchart in the delay time setting process of the present embodiment. The control flowchart of the present embodiment differs in that steps SP148 and SP149 are included instead of steps SP62 and SP66 as shown in FIG. 23.

(Step SP141) As shown in FIG. 20, in the present step, the processor 121 sets the width of the observation region to the target width L1 of the observation region described in step SP131, and advances the control flow to step SP53.

Next, steps SP12 and thereafter will be described with reference to FIG. 21.

(Step SP142) Prior to the present step, since the width of the observation region is set to the target width L1 in step SP141, a plurality of the non-combined droplet targets DL exist in the image data. In the present step, the processor 121 calculates the distance Di between the second detection position P2 and each of all the non-combined droplet targets DL existing in the observation region having the target width L1 in certain image data. Further, the processor 121 performs the calculation of the distance Di for all the image data. That is, in the observation region of the respective image data in the present step, there are k non-combined droplet targets DL, where k is a natural number equal to or more than 2, and the respective non-combined droplet targets DL exist in order away from the second detection position P2. The processor 121 calculates a distance Di-j in each of the non-combined droplet targets DL in each image data. Here, i and j are natural numbers equal to or more than 1. The distance Di-j represents the distance of the non-combined droplet target DL being j-th close to the second detection position P2 in the i-th image data. For example, in the case of three of the image data in which k of the first and second image data is 3 and k of the third image data is 6, twelve distances Di-j being distances D1-1 to D1-3, D2-1 to D2-3, and D3-1 to D3-6 are calculated. As described above, the processor 121 calculates, in each image data, the distance from the second detection position P2 with respect to the droplet target being first close to the second detection position P2 to the droplet target being k-th close to the second detection position P2. In the following description, it is assumed that three non-combined droplet targets DL exist in the first image data. The three non-combined droplet targets DL may be referred to as the non-combined droplet target DL1-1, the non-combined droplet target DL1-2, and the non-combined droplet target DL1-3 in the order of proximity to the second detection position P2. After calculating the distance Di-j for each of the i pieces of image data, the processor 121 advances the control flow to step SP143.

(Step SP143) In the present step, the processor 121 calculates the average distance Dave of the plurality of calculated distances Di-j. Specifically, the processor 121 allocates, as a group, each of the non-combined droplet targets DL in the first image data and the non-combined droplet targets DL in the respective image data other than the first image data having the distance Di-j close to each distance D1-j in the first image data. FIG. 22 is a diagram for explaining this allocation. In FIG. 22, there are three pieces of the image data, that is, i=3, and the first, second, and third pieces of image data are shown as the image data D1, D2, D3. Further, k of the first and second image data D1, D2 is 3, and k of the third image data D3 is 6. In the image data D1, D2, D3, the non-combined droplet targets DL1-1 to DL1-3, DL2-1 to DL2-3, and DL3-1 to DL3-6 are shown in the order of proximity to the second detection position P2. In step SP142, the distance D from the second detection position P2 is calculated for each of the non-combined droplet targets DL in each of the image data D1, D2, D3.

In the present step, based on the calculated distance D, the processor 121 specifies, from among the non-combined droplet targets DL in the second and third image data D2, D3, the non-combined droplet target DL whose distance D is close to the distance D of the non-combined droplet target DL1-1 closest to the second detection position P2 in the first image data D1. In the present step, the non-combined droplet targets DL specified in the second and third image data D2, D3 are described as the non-combined droplet targets DL2-1, DL3-1. The processor 121 then allocates the non-combined droplet targets DL1-1, DL2-1, DL3-1 as a group G1.

Further, based on the calculated distance, the processor 121 specifies, from among the non-combined droplet targets DL in the second and third image data D2, D3, the non-combined droplet target DL whose distance D is close to the distance D of the non-combined droplet target DL1-2 second close to the second detection position P2 in the first image data D1. In the present step, the non-combined droplet targets DL specified in the second and third image data D2, D3 are described as the non-combined droplet targets DL2-2, DL3-4. Then, the processor 121 allocates the non-combined droplet targets DL1-2, DL2-2, DL3-4 as a group G2.

Further, based on the calculated distance, the processor 121 specifies, from among the non-combined droplet targets DL of the second and third image data D2, D3, the non-combined droplet target DL whose distance D is close to the distance D of the non-combined droplet target DL1-3 third close to the second detection position P2 in the first image data D1. In the present step, the non-combined droplet targets DL specified in the second and third image data D2, D3 are described as the non-combined droplet targets DL2-3, DL3-6. Then, the processor 121 allocates the non-combined droplet targets DL1-3, DL2-3, DL3-6 as a group G3.

As described above, the processor 121 specifies the non-combined droplet target DL having a distance close to the distance D, to the second detection position P2, of each of the non-combined droplet targets DL first to k-th close to the second detection position P2 from the image data D2, D3 other than the first image data D1. For example, in the image data D2,D3, the non-combined droplet targets DL2-2, DL3-4 are the non-combined droplet targets DL each having the distance D closest to the distance D of the non-combined droplet target DL1-2 among the non-combined droplet targets DL located within the predetermined allowable range with respect to the distance D of the non-combined droplet target DL1-2. Then, the processor 121 allocates the non-combined droplet target DL in the first image data D1 and the non-combined droplet targets DL specified from the second and third image data D2, D3 as a group. For example, when the non-combined droplet target DL2-2 does not exist in the group G2, the non-combined droplet targets DL1-2, DL3-4 are allocated as the group G2. When the non-combined droplet target DL2-2 does not exist, either the non-combined droplet target DL2-1 or the non-combined droplet target DL2-3 becomes the non-combined droplet target DL having the distance D close to the distance D of the non-combined droplet target DL1-2. However, the distance D of each of the non-combined droplet targets DL2-1, DL2-3 exceeds the predetermined allowable range with respect to the distance D of the non-combined droplet target DL1-2, and is not close to the distance D of the non-combined droplet target DL1-2. Therefore, when the non-combined droplet target DL2-2 does not exist, neither the non-combined droplet target DL2-1 nor the non-combined droplet target DL2-3 is allocated as the group G2.

A plurality of groups are formed by the allocation, and an average distance Davej is calculated for each group. Specifically, the processor 121 calculates an average distance Dave1 of the distances D of the non-combined droplet targets DL1-1, DL2-1, DL3-1 of the group G1 for the non-combined droplet target DL1-1 closest to the second detection position P2 in the first image data D1. Further, the processor 121 calculates an average distance Dave2 of the distances D of the non-coupled droplet targets DL1-2, DL2-2, DL3-4 of the group G2 for the non-combined droplet target DL1-2 second closest to the second detection position P2 in the first image data D1. Further, the processor 121 calculates an average distance Dave3 of the distances D of the non-combined droplet targets DL1-3, DL2-3, DL3-6 of the group G3 for the non-combined droplet target DL1-3 third closest to the second detection position P2 in the first image data D1. After calculating the respective average distances Dave, the processor 121 advances the control flow to step SP144.

(Step SP144) In the present step, the processor 121 calculates the standard deviation σ1 of the variation of the non-combined droplet targets DL1-1, DL2-1, DL3-1 with respect to the second detection position P2 by substituting the number n of the pieces of image data, the distance Di-j, and the average distance Dave1 in the group G1 into expression (1). Similarly, the processor 121 calculates the standard deviation σ2 of the variation of the non-combined droplet targets DL1-2, DL2-2, DL3-4 in the group G2 and the standard deviation σ3 of the variation of the non-combined droplet targets DL1-3, DL2-3, DL3-6 in the group G3. Thus, the processor 121 calculates the standard deviation σ of the non-combined droplet targets DL that are close in distance over the respective image data D1, D2, D3. Thus, k standard deviations σ are calculated. After calculating the standard deviations σ1, σ2, σ3, the processor 121 advances the control flow to step SP145. It is assumed that the standard deviation σ1 is the smallest standard deviation among the standard deviations σ1, σ2, σ3.

(Step SP145) In the present step, when there is no non-combined droplet target DL satisfying standard deviation σ≤threshold σ_limit calculated in step SP144, the processor 121 advances the control flow to step SP61 shown in FIG. 23. Further, when there is a non-combined droplet target DL satisfying standard deviation σ≤threshold σ_limit, the processor 121 advances the control flow to step SP146. That is, the processor 121 advances the control flow to step SP61 shown in FIG. 23 when all of the standard deviations σ1, σ2, σ3 are more than the threshold σ_limit, and advances the control flow to step SP146 if any of the standard deviations σ1, σ2, σ3 is equal to or less than the threshold σ_limit. Further, the processor 121 determines the droplet target DL having the standard deviation equal to or less than the threshold σ_limit among the standard deviations σ1, σ2, σ3 as the droplet target DL synchronized with the imaging timing, and determines that there is a non-combined droplet target DL having the standard deviation equal to or less than the threshold σ_limit.

Next, steps SP148 and SP149 will be described with reference to FIG. 23.

(Step SP148) In the present step, the processor 121 sets, as the delay time td, a value obtained by adding the change time Δt3 of the delay time to the delay time td, and advances the control flow to step SP63. The change time Δt3 is set within a time in which the imaging device 500 can image the droplet target DL in the imaging region, and specifically, has a value obtained by dividing the target width L1 by the velocity of the droplet target DL. The change time Δt3 may be an arbitrary time. The change time Δt3 has a value more than the re-change time Δt2 in the fine adjustment process of the delay time of step SP30.

(Step SP149) In the present step, the processor 121 sets, as the delay time td, a value obtained by subtracting the change time Δt3 of the delay time from the delay time td, and advances the control flow to step SP67.

In present embodiment as well, in step SP64, the processor 121 resets the number n of the pieces of image data to 0, and returns the control flow to step SP54. Since the number n of the pieces of image data is 0, the control flow proceeds from step SP54 to steps SP142, SP143, and SP144 sequentially. Then, using the delay time td set in steps SP148 and SP149, the standard deviation σ is calculated again in step SP144, and in step SP145, it is determined whether or not there is a non-combined droplet target DL satisfying standard deviation σ≤threshold σ_limit. As described above, by repeating the control flow of steps SP54 and steps SP142 to SP145 shown in FIG. 21, the processor 121 specifies the non-combined droplet target DL in which the minimum standard deviation among the plurality of standard deviations σ is equal to or less than the first threshold being the reference σ_limit.

Next, referring back to FIG. 21, steps SP146 and SP147 will be described.

(Step SP146) The delay time td is changed by the change time Δt3 in steps SP148 and SP149, and the delay time td becomes equal to or more than the lower limit delay time td_lower_limit and equal to or less than the upper limit delay time td_upper_limit. In the present step, the processor 121 sets, as the delay time td, a value obtained by adding the change time Δt corresponding to the average distance Dave to the delay time td. The average distance Dave in the present step is the average distance of the non-combined droplet targets DL corresponding to the standard deviation σ that is equal to or less than the threshold σ_limit and is the minimum among the standard deviations σ1, σ2, σ3. The change time Δt is obtained by dividing the average distance Dave by the velocity of the droplet target DL calculated in step SP23. When the delay time td is set, the specified non-combined droplet target DL is located at the second detection position P2. Therefore, in the present step, the processor 121 sets the delay time td based on the average distance Dave to the second detection position P2 from the specified non-combined droplet target DL with which the standard deviation σ1 calculated in step SP144 is equal to or less than the first threshold value, so that the specified non-combined droplet target DL is located at the second detection position P2. After setting the delay time td, the processor 121 advances the control flow sequentially to steps SP60 and SP147.

(Step SP147) In the present step, the processor 121 sets the width of the observation region to the initial width L0 of the observation region described in step SP131, ends the delay time setting process, and advances the control flow to step SP25.

In the fine adjustment process of the delay time of the present embodiment, in steps SP84 and SP85, the processor 121 sets the re-change time Δt2 of the delay time to be less than the change time Δt3. Therefore, after setting the delay time td in the delay time setting process of step SP24, when the distance from the second detection position P2 to the combined droplet target DL in the imaging region is more than the second threshold in step SP82, the processor 121 resets the delay time td based on the re-change time Δt2 of the delay time less than the change time Δt3.

### 6.3 Effect

In the EUV light generation apparatus 100 of the present embodiment as well, even when the detection device 400 and the imaging device 500 deviate from the installation positions set in advance in the chamber 10, the irradiation with the laser light 90 to a droplet target DL different from the droplet target DL assumed in advance can be suppressed. Further, even when the velocity of the droplet target DL slightly varies, the deviation of the irradiation position on the combined droplet target DL assumed in advance can be suppressed. Therefore, the laser light 90 that satisfies the performance required by the exposure apparatus 200 or the inspection apparatus 300 can be output, and a decrease in reliability of the EUV light generation apparatus 100 can be suppressed.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

Further, it would be also obvious to those skilled in the art that embodiments of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An extreme ultraviolet light generation apparatus, comprising:
a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance;
a target passage detection device configured to detect passage of the droplet target, at a first detection position, supplied from the target supply unit into a chamber and output a passage timing signal at each time of the detection;
a delay circuit configured to receive the passage timing signal and output a light emission trigger signal and an imaging trigger signal at a timing delayed by a given delay time from the reception of the passage timing signal;
a laser device configured to generate extreme ultraviolet light by irradiating, with laser light, the droplet target at a second detection position on a downstream side from the first detection position in a travel direction of the droplet target, at each time the light emission trigger signal is input;
a target image capturing device configured to image the droplet target located in a region including the second detection position and generate image data of the region and the droplet target located in the region, at each time the imaging trigger signal is input; and
a processor,
the processor being configured to control the vibrating element so that an interval between the adjacent droplet targets becomes irregular, specify the droplet targets with which standard deviation of a distance from the second detection position to each droplet target is equal to or less than a first threshold, and set the delay time based on a distance from each of the specified droplet targets to the second detection position so that the specified droplet targets are to be located at the second detection position.

2. The extreme ultraviolet light generation apparatus according to claim 1,
wherein the processor controls a frequency of the vibrating element to 0.

3. The extreme ultraviolet light generation apparatus according to claim 1,
wherein the processor controls a frequency of the vibrating element in an irregular manner.

4. The extreme ultraviolet light generation apparatus according to claim 1,
wherein the processor specifies the droplet targets with which the standard deviation of the distance from the second detection position to each droplet target closest to the second detection position is equal to or less than the first threshold.

5. The extreme ultraviolet light generation apparatus according to claim 4,
wherein, when the droplet targets with which the standard deviation is equal to or less than the first threshold cannot be specified, the processor sets a change time Δt1 of the delay time to a time equal to or less than a generation cycle of the droplet targets in a case that an interval between the adjacent droplet targets is constant and specifies the droplet targets with which the standard deviation becomes equal to or less than the first threshold.

6. The extreme ultraviolet light generation apparatus according to claim 5,
wherein the processor sets a re-change time Δt2 of the delay time to be less than the change time Δt1 to reset the delay time when a distance from the second detection position to the droplet target in the region is more than a second threshold after setting the delay time.

7. The extreme ultraviolet light generation apparatus according to claim 1,
wherein, where k is a natural number equal to or more than 2, the processor calculates, in each image data, a distance from the second detection position to each of the droplet targets being first to k-th close to the second detection position; specifies the droplet targets, from each image data other than first image data, each having a distance to the second detection position close to the distance of each of the droplet targets being first to k-th close to the second detection position in the first image data; calculates the standard deviation for the droplet targets that are close in the distance over the respective image data; and specifies the droplet targets with which the standard deviation among k values of the standard deviations is equal to or less than the first threshold.

8. The extreme ultraviolet light generation apparatus according to claim 7,
wherein, when the droplet targets with which the standard deviation is equal to or less than the first threshold cannot be specified, the processor sets a change time Δt3 of the delay time to be equal to or less than a time in which the target image capturing device is capable of imaging the droplet target in the region; and specifies the droplet targets with which the standard deviation being minimum among the k values of the standard deviations is equal to or less than the first threshold.

9. The extreme ultraviolet light generation apparatus according to claim 8,
wherein the processor sets a re-change time Δt2 of the delay time to be less than the change time Δt3 to reset the delay time when a distance from the second detection position to the droplet target in the region is more than a second threshold after setting the delay time.

10. The extreme ultraviolet light generation apparatus according to claim 1,
wherein the standard deviation is calculated by following expression (1),
$$σ = \sqrt{\frac{1}{n} {\sum }_{i = 1}^{n} {( Di - Dave )}^{2}} \qquad ( 1 )$$
where n represents a number of plural pieces of the captured image data, Di represents a distance from the second detection position to the droplet target in each of the plural pieces of image data, Dave represents an average distance of a plurality of the distances Di, and σ represents the standard deviation.

11. An electronic device manufacturing method, comprising:
outputting extreme ultraviolet light generated using an extreme ultraviolet light generation apparatus to an exposure apparatus; and
exposing a photosensitive substrate to the extreme ultraviolet light in the exposure apparatus to manufacture an electronic device,
the extreme ultraviolet light generation apparatus including:
a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance;
a target passage detection device configured to detect passage of the droplet target, at a first detection position, supplied from the target supply unit into a chamber and output a passage timing signal at each time of the detection;
a delay circuit configured to receive the passage timing signal and output a light emission trigger signal and an imaging trigger signal at a timing delayed by a given delay time from the reception of the passage timing signal;
a laser device configured to generate the extreme ultraviolet light by irradiating, with laser light, the droplet target at a second detection position on a downstream side from the first detection position in a travel direction of the droplet target, at each time the light emission trigger signal is input;
a target image capturing device configured to image the droplet target located in a region including the second detection position and generate image data of the region and the droplet target located in the region, at each time the imaging trigger signal is input; and
a processor,
the processor being configured to control the vibrating element so that an interval between the adjacent droplet targets becomes irregular, specify the droplet targets with which standard deviation of a distance from the second detection position to each droplet target is equal to or less than a first threshold, and set the delay time based on a distance from each of the specified droplet targets to the second detection position so that the specified droplet targets are to be located at the second detection position.

12. An electronic device manufacturing method, comprising:
inspecting a defect of a mask by irradiating the mask with extreme ultraviolet light generated using an extreme ultraviolet light generation apparatus;
selecting a mask using a result of the inspection; and
exposing and transferring a pattern formed on the selected mask onto a photosensitive substrate,
the extreme ultraviolet light generation apparatus including:
a target supply unit including a tank configured to store a target substance, a pressure regulator configured to regulate pressure in the tank, a nozzle configured to output the target substance from the tank, and a vibrating element configured to apply vibration to the target substance to be output from the nozzle to generate a droplet target of the target substance;
a target passage detection device configured to detect passage of the droplet target, at a first detection position, supplied from the target supply unit into a chamber and output a passage timing signal at each time of the detection;
a delay circuit configured to receive the passage timing signal and output a light emission trigger signal and an imaging trigger signal at a timing delayed by a given delay time from the reception of the passage timing signal;
a laser device configured to generate the extreme ultraviolet light by irradiating, with laser light, the droplet target at a second detection position on a downstream side from the first detection position in a travel direction of the droplet target, at each time the light emission trigger signal is input;
a target image capturing device configured to image the droplet target located in a region including the second detection position and generate image data of the region and the droplet target located in the region, at each time the imaging trigger signal is input; and
a processor,
the processor being configured to control the vibrating element so that an interval between the adjacent droplets targets becomes irregular, specify the droplet targets with which standard deviation of a distance from the second detection position to each droplet target is equal to or less than a first threshold, and set the delay time based on a distance from each of the specified droplet targets to the second detection position so that the specified droplet targets are to be located at the second detection position.
